(19) United States
(12) Patent Application Publication
(10) Pub. No.: US 2015/0352820 A1
(43) Pub. Date: Dec. 10, 2015

(54) PLANAR COMPOSITE HAVING LAYERS OF PLASTIC FROM PLASTICS WITH DIFFERENT DAMPING PROPERTIES, HAVING A LAYER COMPRISING LLDPE

(71) Applicant: SIG TECHNOLOGY AG, Neuhausen (CH)

(72) Inventors: Mike DUISKEN, Linnich (DE); Roland BOTHOR, Aachen (DE); Michael WOLTERS, Heinsberg (DE)

(21) Appl. No.: 14/762,310

(22) PCT Filed: Jan. 24, 2014
(86) PCT No.: PCT/EP2014/000187

§ 371 Date: Jul. 21, 2015

(30) Foreign Application Priority Data
Jan. 26, 2013 (DE) 10 2013 001 263.5

(51) Int. Cl. B32B 27/32; B32B 1/02; B32B 27/10; B32B 3/26; B32B 7/02; B32B 27/06

(52) U.S. Cl. CPC B32B 27/32; B32B 7/02; B32B 27/06; B32B 27/10; B32B 27/327; B32B 3/266; B32B 1/02; B32B 2270/00; B32B 2307/54; B32B 2307/5825; B32B 2439/70

(57) ABSTRACT

The present invention relates generally to a planar composite comprising as a layer sequence: i. a carrier layer; ii. a barrier layer; wherein the layer sequence comprises a first blend layer; wherein the first blend layer comprises an LLDPE; wherein the first blend layer comprises the LLDPE in a range of from 10 wt. % to 99.9 wt. %, based on the blend layer; and wherein the first blend layer has a damping factor difference in a range of from −0.3 to −0.6. The present invention furthermore relates to a process for the production of the planar composite, a container which surrounds an interior and comprises at least one such planar composite, and a process for the production of this container, which comprises the steps of provision of the planar composite of the abovementioned layer construction, folding, joining and optionally filling and closing of the container obtained in this way.

The present invention relates generally to a planar composite comprising as the layer sequence: i. a carrier layer; ii. a barrier layer; wherein the layer sequence comprises a first blend layer, wherein the first blend layer comprises an LLDPE; wherein the first blend layer comprises the LLDPE in a range of from 10 wt. % to 99.9 wt. %, based on the blend layer; and wherein the first blend layer has a damping factor difference in a range of from −0.3 to −0.6.

The present invention further relates to a process for the production of the planar composite, wherein the planar composite comprises a carrier layer and a barrier layer; comprising the steps: S1. provision of a blend comprising an LLDPE and a polyolefin which differs from LLDPE, wherein the blend comprises the LLDPE in a range of from 10 to 99.9 wt. %, based on the blend; S2. application of the blend to a composite precursor, wherein the composite precursor comprises a carrier layer.

The present invention furthermore relates to a container which surrounds an interior and comprises at least one such planar composite, and a process for the production of this container which comprises the steps of provision of the planar composite of the abovementioned layer construction, folding, joining and optionally filling and closing of the container obtained in this way. The invention likewise relates to the use of a composite according to the invention for storage of foodstuffs.

For a long time foodstuffs, whether foodstuffs for human consumption or also animal feed products, have been preserved by being stored either in a can or in a glass jar closed with a lid. However, these packaging systems have some serious disadvantages, inter alia the high intrinsic weight, the energy-intensive production and the troublesome opening.

Alternative packaging systems for storing foodstuffs for a long period of time as far as possible without impairment are known from the prior art. These are containers produced from planar composites—often also called laminate. Such planar composites are often built up from a layer of thermoplastic, a carrier layer usually comprising cardboard or paper, an adhesion promoter layer, an aluminium layer and a further layer of plastic. Such a planar composite is disclosed, inter alia, in WO 90/09926. Such laminated containers already have many advantages over the conventional glass jars and cans, for example space-saving storage and low intrinsic weight.

The use of “low-density polyethylene, LDPE” layers in the production of containers such as are described in EP 1 020 480 and EP 1 777 238 represents a further development of such planar composites. In these, the polymer coatings are produced by an autoclave process with a subsequent extruding process of the polymer on a carrier. A specific pressure and temperature management of the production process can be achieved with the aid of these autoclave processes. Nevertheless, possibilities for improvement also exist for these packaging systems.

Thus, in the production process, in particular during application of the polymer layers of the abovementioned containers, tearing off of the PE layers or perforation occurs again and again, especially in the creasing regions of the containers. Damage and defects in the packaging can consequently occur, as a result of which this is damaged visually and functionally, above all inside the planar composite. This is particularly undesirable, since this step is at the end of the creation of value and higher costs are therefore caused by withdrawal of damaged packs and claims due to leaks.

In the case of containers with scores in particular, in these chiefly at the container creasing points, such tearing off of the polymer layer can lead to malfunctions, such as leakiness, which are noticed only during use, for example filling or even only later by shortened storage times of such a container.

In the use, as also the transportation, of such containers, a low puncture resistance and a low breaking strength of the PE layers also leads to the container leaking under the slightest exposure to load. In particular, after opening of the container a high tear propagation capacity of the PE layers can lead to the container tearing open beyond the hole for opening, thus leading to difficulties during pouring out.

In particular, during one selected from the group consisting of a production of a planar composite, a transportation of a container precursor, a filling of a preformed container with foodstuff and a transportation of a filled container to a consumer or a combination of at least two thereof the hole-covering layer of a planar composite and/or a container having a carrier layer comprising a hole which is covered by a hole-covering layer can be damaged.

Generally, the object of present invention is to at least partly eliminate the disadvantages emerging from the prior art.

The object is furthermore to create a planar composite which has a high stability and leakproofness.

An object is furthermore to provide a container from a composite, wherein the container should be producible by easy folding of the composite and at the same time should have a high leakproofness. The container should therefore be particularly well-suited to long-term storage of sensitive foodstuffs.

A further object is to create a planar composite which can be produced efficiently and inexpensively.

An object in turn is to create a planar composite which can be produced as quickly as possible and without a high reject rate.

A further object is to provide a planar composite which is suitable in particular for the production of containers for transportation and storage of foodstuffs, animal feeds, drinks of low carbonic acid content and the like.

A further object is to create a planar composite which has the highest possible puncture resistance and a high breaking strength.

An object in turn is to create a planar composite which shows the lowest possible tear propagation capacity when the planar composite is torn into, e.g. during opening of a container made of the composite.

An object is furthermore to provide a process for the production of a planar composite which is as far as possible efficient and inexpensive as well as fast and of low susceptibility to defects.

A further object is to improve the processability of the materials used in the production, in particular to minimize the neck-in during application of thermoplastics by extrusion, in particular of blend layers. A further object in turn is to increase the speed in the production of planar composites, in particular to optimize the draw-down ratio of the materials to be processed.

An object is furthermore to provide a planar composite which tends towards as few defects as possible, in particular during folding in the cold, as a result of which a packaging container having a good leakproofness can be produced. An object is furthermore to provide a container which has the highest possible puncture resistance, a high breaking strength and a low tear propagation capacity.

It is a further object of the present invention to provide a planar composite or a container or both comprising a hole-covering layer being characterized by a high elongation at break or a high elongation factor or both.

It is yet a further object of the invention to provide a planar composite or a container or both comprising a hole-covering layer with a balanced combination of properties such as elongation factor, puncture resistance, breaking strength and tear propagation capacity.

A contribution towards achieving at least one of the abovementioned objects is made by the subject matter of the classifying claims. The subject matter of the sub-claims which are dependent upon the classifying claims represents preferred embodiments of this contribution towards achieving the objects.

A contribution towards achieving at least one of the above objects is made by a planar composite comprising as a layer sequence:
i. a carrier layer;
ii. a barrier layer;

wherein the layer sequence comprises a first blend layer;
wherein the first blend layer comprises an LLDPE;
wherein the first blend layer comprises the LLDPE in a range of from 10 wt. % to 99.9 wt. %, or preferably in a range of from 15 to 90 wt %, or preferably in a range of from 20 to 80 wt. %, based on the blend layer; and
wherein the first blend layer has a damping factor difference in a range of from −0.3 to −0.6, preferably in a range of from −0.33 to −0.55, preferably in a range of from −0.37 to −0.54 and furthermore preferably in a range of from −0.37 to −0.425.

The first blend layer can be provided at any conceivable position of the layer sequence. Thus the first blend layer can be provided in a layer sequence with the first blend layer followed by the carrier layer and the barrier layer, wherein the layers can follow one another directly or indirectly. Preferably, the layers follow one another directly. Furthermore, the first blend layer can be provided in a layer sequence with the carrier layer, followed by the barrier layer, followed by the first blend layer, wherein the layers can follow one another directly and indirectly. Furthermore, the first blend layer can be provided in a layer sequence with the carrier layer, followed by the first blend layer, followed by the barrier layer, wherein the layers can follow one another directly and indirectly. In a use, described later, of the planar composite as a container, it is preferable for the two layers of the carrier layer and the barrier layer to be arranged relative to one another such that the carrier layer faces the outside of the container and the barrier layer faces the inside of the container, wherein further layers, such as, for example, the first or further blend layers, can be present towards the outside of the container, in the middle and towards the inside of the container. In the following, those layers which are adjacent to the barrier layer towards the inside of the container are called inner-lying layers and those layers which are adjacent to the carrier layer towards the outside are called outer-lying layers.

In a preferred embodiment of the planar composite, the blend layer comprises a polyolefin which differs from LLDPE.

The polyolefin which differs from LLDPE is preferably chosen from the group consisting of an LDPE, an HDPE, an m-PE, a polypropylene (PP) or a mixture of at least two of these. The first blend layer comprises the polyolefin which differs from LLDPE preferably in a range of from 0.1 to 20 wt. %, preferably in a range of from 0.5 to 15 wt. %, or preferably in a range of from 1 to 10 wt. %, based on the blend layer.

Preferably, the polyolefin which differs from LLDPE comprises an LDPE. The polyolefin which differs from LLDPE preferably comprises an LDPE chosen from the group consisting of an LDPEa and an LDPEt or a mixture of these. Preferably, the LDPE comprises the LDPEa in a range of from 50 to 90 wt. %, preferably in a range of from 55 to 85 wt. %, or preferably in a range of from 60 to 80 wt. %, in each case based on the LDPE. It is furthermore preferable for the LDPEt to be present in the LDPE of the blend layer in a range of from 10 to 50 wt. %, preferably in a range of from 15 to 45 wt. % and particularly preferably in a range of from 20 to 40 wt. %, in each case based on the LDPE.

The differentiation between the LLDPE and the polyolefin which differs from LLDPE, for example the LDPEa and the LDPEt, is preferably made by their damping properties. The damping properties, specifically the damping factor 8, at various frequencies of a rotary rheometer can be determined with the aid of test specimens of the particular material. Details of this determination are to be found under the test methods.

In another embodiment of the invention the first blend layer comprises the LLDPE in a range of from 10 to 99.9 wt. %, or preferably in a range of from 40 to 99.9 wt. %, or preferably in a range of from 45 to 90 wt. %, or preferably in a range of from 50 to 80 wt.-%, in each case based on the first blend layer. The first blend layer can comprise the polyolefin which differs from LLDPE preferably in a range of from 0.01 to 90 wt.-%, or preferably in a range of from 0.01 to 60 wt. %, or preferably in a range of from 10 to 55 wt. %, or preferably in a range of from 20 to 50 wt-%, in each case based on the first blend layer.

According to the invention, the damping factor differences of the constituents of the first blend layer are in a range of from −0.3 to −0.6, preferably in a range of from −0.31 to −0.55, particularly preferably in a range of from −0.32 to −0.52.

The damping factor differences of LLDPE and the polyolefin which differs from LLDPE, such as, for example, LDPEa and LDPEt, are furthermore preferably in different ranges. Thus it is preferable for the damping factor difference of the LLDPE, and possibly a constituent of the polyolefin which differs from LLDPE, such as, for example, the LDPEa, to be in a range of from −0.30 to below −0.40, while the damping factor difference of further constituents of the blend layer, such as, for example, the LDPEt, is in a range of from −0.40 to −0.60, preferably in a range of from −0.41 to −0.55, or preferably in a range of from −0.42 to −0.52.

In a preferred embodiment of the planar composite, the LLDPE has a damping factor difference of less than −0.4.

In a further preferred embodiment of the planar composite, the first blend layer has a damping factor difference in a range of from −0.32 to −0.50.

Surprisingly, it has now been found that by mixing, that is to say the formation of a blend, of the various polyolefins, preferably the LLDPE and the LDPE, various properties of the blend formed do not correspond to the expected average of the properties of the individual constituents. This is found above all for the damping properties, but also for the flow properties during extrusion of the blend. Thus it is preferable, for example, to use in the extrusion process polymers which have a low “neck-in” value. The neck-in value indicates how severely the polymer film constricts between the die opening and the substrate to be coated. The neck-in value is calculated from the difference between the die width and the film width on the substrate.

Preferably, the neck-in value is less than 100 mm, particularly preferably less than 90 mm, very particularly preferably less than 85 mm. More precise information on the determination of the neck-in value is to be found in the test methods and examples.

A further indication of the unexpected properties of the mixtures of LLDPE and the polyolefin which differs from LLDPE in the stated ranges is the improved “draw-down ratio”. The draw-down ratio, DDR for short, is to be understood as meaning the greatest acceleration of the molten polymer film, of the extruded polymer, between the die opening and the substrate to be coated before the film tears. The DDR is calculated from the ratio of the die lip and the thickness of the film. The higher the DDR value, the more quickly a plastic can be extruded and coated on to a substrate in a stable manner. More precise information on the determination of the draw-down ratio is to be found in the test methods and examples.

Due to these particular properties of the mixtures of LLDPE and the polyolefin which differs from LLDPE, preferably of LLDPE and LDPE, extrusion speeds of from 1 to 20 m/sec, preferably from 2 to 15 m/sec, or preferably from 3 to 12 m/sec can be achieved.

In a preferred embodiment of the planar composite, the first blend layer has at least one, preferably each of the following properties:
P1. a melt flow rate (MFR) in a range of from 1 to 25 g/10 min;
P2. a melting temperature (T_{p,m}) in a range of from 90 to 150° C.;
P3. a density in a range of from 0.900 to 0.940 g/cm³;
P4. an average molecular weight (M_{w}) in a range of from 3*10³ to 1*10⁷ g/mol;
P5. prepared with a C₃ to C₁₁ alpha-olefin content in a range of from 0.1 to 15 wt. %, based on the LLDPE.

The first blend layer can have any desired combination of the properties P1 to P5. Preferably, the first blend layer has a combination of at least two properties chosen from the group consisting of P1 and P2, P1 and P3, P1 and P4, P1 and P5, P2 and P3, P2 and P4, P2 and P5, P3 and P4, P3 and P5, P4 and P5, P1 and P2 and P3, P1 and P2 and P4, P1 and P2 and P5, P1 and P3 and P4, P1 and P3 and P5, P1 and P4 and P5, P2 and P3 and P4, P2 and P3 and P5, P2 and P4 and P5, P3 and P4 and P5, P1 and P2 and P3 and P4, P1 and P2 and P3 and P5, P1 and P2 and P4 and P5, P1 and P2 and P3 and P5, P2 and P3 and P4 and P5. Preferably, the first blend layer has all the properties P1 to P5.

Particularly suitable blend layers have a melt flow rate (MFR) in a range of from 1 to 25 g/10 min, preferably in a range of from 2 to 20 g/10 min and particularly preferably in a range of from 2.5 to 15 g/10 min. Preferably, suitable blend layers, such as the first blend layer, have a melting temperature (T_{p,m}) in a range of from 90 to 150° C., preferably in a range of from 95 to 145° C., or preferably in a range of from 100 to 140° C. Preferably, suitable blend layers have a density in a range of from 0.900 g/cm³ to 0.940 g/cm³, preferably in a range of from 0.905 g/cm³ to 0.935 g/cm³, and further preferably in a range of from 0.910 g/cm³ to 0.930 g/cm³. The blend layers, for example the first blend layer, preferably have an average molecular weight (M_{w}) in a range of from 3*10³ to 1*10⁷ g/mol, preferably in a range of from 5*10³ to 5*10⁶ g/mol and particularly preferably in a range of from 1*10⁴ to 1*10⁶ g/mol. Preferably, the LLDPE is prepared as a copolymer of ethene and an olefin. The olefin is preferably an alpha-olefin. The alpha-olefin can be branched or linear. The alpha-olefin is preferably linear. The olefin is preferably chosen from the group consisting of a propene, a butene, a pentene, a hexene, a heptene, an octene, a nonene, a decene and an undecene or a combination of at least two of these. The olefin is furthermore preferably chosen from the group consisting of propene, 1-butene, 1-pentene, 1-hexene, 1-heptene, 1-octene, 1-nonene, 1-decene and 1-undecene or a combination of at least two of these. The LLDPE is preferably prepared with a C₃ to C₁₁ alpha-olefin content in a range of from 0.1 to 15 wt. %, preferably in a range of from 0.2 to 12 wt. %, or preferably in a range of from 0.3 to 10 wt. %, based on the LLDPE. The LLDPE is preferably prepared with an ethene content in a range of from 70 to 100 wt. %, preferably in a range of from 80 to 99.9 wt. %, or preferably in a range of from 85 to 95 wt. %.

The planar composite according to one of the preceding claims, wherein the LLDPE has at least one, preferably each of the following properties:
LL1. a melt flow rate (MFR) in a range of from 1 to 15 g/10 min;
LL2. a melting temperature (T_{p,m}) in a range of from 110 to 150° C.;
LL3. a density in a range of from 0.910 to 0.940 g/cm³;
LL4. an average molecular weight (M_{w}) in a range of from 3*10³ to 1*10⁷ g/mol;
LL5. prepared with a C₃ to C₁₁ alpha-olefin content in a range of from 0.1 to 15 wt. %, based on the LLDPE.
   The LLDPE can have any desired combination of the properties LL1 to LL5. Preferably, the LLDPE has a combination of at least two properties chosen from the group consisting of LL1 and LL2, LL1 and LL3, LL1 and LL4, LL1 and LL5, LL2 and LL3, LL2 and LL4, LL2 and LL5, LL3 and LL4, LL3 and LL5, LL4 and LL5, LL1 and LL2 and LL3, LL1 and LL2 and LL4, LL1 and LL2 and LL5, LL1 and LL3 and LL4, LL1 and LL3 and LL5, LL1 and LL4 and LL5, LL2 and LL3 and LL4, LL2 and LL3 and LL5, LL2 and LL4 and LL5, LL3 and LL4 and LL5, LL1 and LL2 and LL3 and LL4, LL1 and LL2 and LL3 and LL5, LL1 and LL2 and LL4 and LL5, LL2 and LL3 and LL4 and LL5. Preferably, the LLDPE has all the properties LL1 to LL5.

The LLDPE preferably has a melt flow rate (MFR) in a range of from 1 to 15 g/10 min, preferably in a range of from 1.5 to 13 g/10 min and particularly preferably in a range of from 2 to 10 g/10 min. Preferably, the LLDPE has a melting temperature (T_{p,m}) in a range of from 110 to 150° C., preferably in a range of from 115 to 145° C., or preferably in a range of from 120 to 140° C. Preferably, suitable LLDPE have a density in a range of from 0.910 g/cm³ to 0.940 g/cm³, preferably in a range of from 0.915 g/cm³ to 0.935 g/cm³, and further preferably in a range of from 0.920 g/cm³ to 0.930 g/cm³. The LLDPE preferably has an average molecular weight (M_{w}) in a range of from 3*10³ to 1*10⁷ g/mol, preferably in a range of from 5*10³ to 5*10⁶ g/mol and particularly preferably in a range of from 1*10⁴ to 1*10⁶ g/mol. Preferably, the LLDPE is prepared as a copolymer of ethene and an olefin. The olefin is preferably an alpha-olefin. The alpha-olefin can be branched or linear. The alpha-olefin is preferably linear. The olefin is preferably chosen from the group consisting of a propene, a butene, a pentene, a hexene, a heptene, an octene, a nonene, a decene and an undecene or a combination of at least two of these. The olefin is furthermore preferably chosen from the group consisting of propene, 1-butene, 1-pentene, 1-hexene, 1-heptene, 1-octene, 1-nonene, 1-decene and 1-undecene or a combination of at least two of these. The LLDPE is preferably prepared with a C₃ to C₁₁ alpha-olefin content in a range of from 0.1 to 15 wt. %, preferably in a range of from 0.2 to 12 wt. %, or preferably in a range of from 0.3 to 10 wt. %, based on the LLDPE. The LLDPE is preferably prepared with an ethene content in a range of from 70 to 100 wt. %, preferably in a range of from 80 to 99.9 wt. %, or preferably in a range of from 85 to 95 wt. %.

The planar composite (3) according to one of the preceding claims, wherein the polyolefin which differs from LLDPE has at least one, preferably each of the following properties:
L1. a melt flow rate (MFR) in a range of from 1 to 25 g/10 min;
L2. a melting temperature (T_{p,m}) in a range of from 90 to 130° C.;
L3. a density in a range of from 0.90 to 0.94 g/cm³;
L4. an average molecular weight (M_{w}) in a range of from 3*10³ to 1*10⁷ g/mol.

The polyolefin which differs from LLDPE can have any desired combination of the properties L1 to L4. Preferably, the polyolefin which differs from LLDPE has a combination of at least two properties chosen from the group consisting of L1 and L2, L1 and L3, L1 and L4, L2 and L3, L2 and L4, L3 and L4, L1 and L2 and L3, L1 and L2 and L4, L1 and L3 and L4, L2 and L3 and L4, L1 and L2 and L3 and L4. Preferably, the polyolefin which differs from LLDPE has all the properties L1 to L4.

The polyolefin which differs from LLDPE preferably has a melt flow rate (MFR) in a range of from 1 to 25 g/10 min, preferably in a range of from 2 to 20 g/10 min and particularly preferably in a range of from 2.5 to 15 g/10 min. Preferably, the polyolefin which differs from LLDPE has a melting temperature (T_{p,m}) in a range of from 90 to 130° C., preferably in a range of from 95 to 125° C., or preferably in a range of from 100 to 120° C. Preferably, the polyolefin which differs from LLDPE has a density in a range of from 0.900 g/cm³ to 0.940 g/cm³, preferably in a range of from 0.905 g/cm³ to 0.935 g/cm³, and further preferably in a range of from 0.910 g/cm³ to 0.930 g/cm³. The polyolefin which differs from LLDPE preferably has an average molecular weight (M_{w}) in a range of from 3*10³ to 1*10⁷ g/mol, preferably in a range of from 5*10³ to 5*10⁶ g/mol and particularly preferably in a range of from 1*10⁴ to 1*10⁶ g/mol.

The two LDPE forms LDPEa or LDPEt or both form the main constituent of the polyolefin which differs from LLDPE in the blend layer.

In a preferred embodiment of the planar composite, the polyolefin which differs from LLDPE is chosen from the group consisting of an LDPE, an LDPEa, an LDPEt or a mixture of these. In a preferred embodiment of the planar composite, the LDPEa or the LDPEt has a density in a range of from 0.915 g/cm³ to 0.940 g/cm³.

The LDPEa differs from the LDPEt in that it is prepared by means of an autoclave process, whereas the LDPEt is prepared by means of a tubular reactor.

In a preferred embodiment of the planar composite, the LDPEa is obtainable from the reaction in an autoclave.

In a preferred embodiment of the planar composite, the LDPEt is obtainable from the reaction in a tubular reactor.

In a further preferred embodiment of the planar composite, the LDPEa is obtainable from the reaction in an autoclave reactor.

Both a tube process in a tubular reactor and an autoclave process in an autoclave reactor are preferably carried out under increased pressure.

In the autoclave process in an autoclave reactor, the polymerization is carried out in an autoclave having a length/diameter ratio in general of between 1 and 25 in the case of a single-zone reactor. In the case of a multi-zone reactor, the ratio of the length of each zone/diameter is as a rule 0.5 to 20, preferably 1 to 10. It goes without saying that the reaction medium flows in the longitudinal direction. The pressure in the autoclave reactor can be, for example, between 100 and 250 MPa, preferably between 120 and 180 MPa, for example between 140 and 170 MPa. The temperature in the autoclave reactor can be between 180 and 300° C. and preferably between 240 and 290° C.

On the basis of the difficulty of producing bimodal molecular weight distributions in tube processes, the autoclave process is used in parallel. However, the combination of an autoclave reactor in series or in parallel with a tubular reactor is likewise suitable for producing bimodal molecular weight distributions.

The preferred autoclave reactor is a continuous autoclave having a length to diameter ratio of from 1 to 16. The autoclave reactor can comprise one or more reaction zones by incorporation of several baffle systems conventional in the technical field. The autoclave reactor can likewise be present in series with one or more other reactors, and the autoclave reactor can additionally be provided with one or more entry points for monomers.

In the tube process, the polymerization takes place in a tubular reactor. A tubular reactor comprises, for example, cylinders, the diameter of which is usually between 1 cm and 3 m, preferably in a range of from 2 cm to 1 m, particularly preferably in a range of from 3 cm to 50 cm, and the length of which is usually between 0.1 to 3 km. This can correspond to a length to diameter ratio of from 100 to 300,000. The shape of a tubular reactor can be, for example, straight or curved, for example comprising U-shaped regions. A tubular reactor which is configured in the form of a spiral is preferred. In a tubular reactor, the reaction medium is stimulated with a high speed, usually over 2 m per second, and short reaction times, for example between 0.1 and 5 min. The pressure in the tubular reactor can be, for example, between 200 and 350 MPa, preferably between 210 and 280 MPa, for example between 230 and 250 MPa. The temperature in the tubular reactor can be between 120 and 350° C. and preferably between 150 and 300° C.

Both in the autoclave reactor and in the tubular reactor, ethylene which contains a free radical starter or initiator is passed through a preheating zone, where it is heated to 100-200° C. The mixture is then passed through an autoclave or a tube, where it is heated up to 250-300° C., when the polymerization starts, although some of the heat is removed by cooling. The pressure, temperature and starter type are all variables which influence the properties of the polyethylene in a manner such as is known to persons skilled in the art. Free radical starters which can be used are all the known free radical starters which are known to the person skilled in the art for starting the polymerization of ethylene to give polyethylene. Any compound which contains one or more atoms or atom groups which can be transferred as free radicals under the polymerization conditions of the autoclave or tube process can be employed as the starter, or also called initiator. The preferred initiators include benzyl halides, such as p-chloromethylstyrene, benzyl chloride, benzyl bromide, 1-bromo-1-phenylethane and 1-chloro-1-phenylethane. Carboxylic acid derivatives, for example propyl 2-bromopropionate, methyl 2-chloropropionate, ethyl 2-chloropropionate, methyl 2-bromopropionate or ethyl 2-bromoisobutyrate, are furthermore particularly preferred. Tosyl halides, such as p-toluenesulphonyl chloride; alkyl halides, such as carbon tetrachloride, tribromoethane, 1-vinylethyl chloride or 1-vinylethyl bromide; and halogen derivatives of phosphoric acid esters, such as dimethylphosphonic acid chloride, are also preferred. In a preferred embodiment of the invention, peroxides or oxygen or both are employed as starters.

The LLDPE can be prepared by any process known to the person skilled in the art for providing an LLDPE which has the properties listed above. Preferably, the LLDPE is prepared by a process with the aid of a metal catalyst. An example of a process for the preparation of the LLDPE is the Ziegler-Natta process. In this context, metal compounds chosen from the group consisting of a titanium ester, a titanium halide, an aluminium-alkyl or a combination of at least two of these can be used as the metal catalyst. The process for the preparation of the LLDPE is preferably carried out under conditions chosen from the group consisting of low temperature, for example in the range of from 20 to 150° C., and low pressure, for example 1 to 50 bar, or both. Preferably, the LLDPE has a molecular weight distribution, also called polydispersity M_{w}/Mₙ, of >3, wherein M_{w} represents the average molecular weight and Mₙ represents the number-average molecular weight. Commercially obtainable LLDPE are obtainable, for example, under the trade names Ineos® LL2640AC, Sabic® LLDPE 318B, ExxonMobile™ LLDPE LL 1004YB.

In a preferred embodiment of the planar composite, the first blend layer contains a metallocene in a concentration of less than 1 wt. %, preferably of less than 0.0001 wt. %, or preferably of less than 0.000001 wt. %, based on the first blend layer. A metallocene is an organometallic compound in which a central metal atom is arranged between two organic ligands, such as, for example, cyclopentadienyl ligands. The polydispersity of the m-LLDPE prepared by means of a metallocene is usually in ranges of M_{w}/Mₙ≦3. EP 1 164 085 A1 describes the preparation of m-LLDPE by way of example. The molecular weight ratios of the m-LLDPE are stated in paragraph [0068] of EP 1 164 085 A1.

In a preferred embodiment of the planar composite, the layer sequence comprises a further blend layer. Preferably, the further blend layer comprises a PE blend layer. Preferably, the further blend layer is built up in exactly the same way as the first blend layer. Particularly preferably, the further blend layer comprises an LLDPE. Furthermore preferably, the further blend layer comprises the LLDPE in a range of from 10 wt. % to 99.9 wt. %, based on the further blend layer. The further blend layer can moreover comprise a polyolefin which differs from LLDPE. Preferably, the further blend layer comprises the polyolefin which differs from LLDPE in a range of from 0.1 to 20 wt. %, preferably in a range of from 0.5 to 15 wt. %, or preferably in a range of from 1 to 10 wt. %, based on the further blend layer. Preferably, the further blend layer has a damping factor difference in a range of from −0.3 to −0.6. Preferably, in connection with the further blend layer this is provided with the first blend layer in a planar composite according to the invention. The layer sequence comprising blend layer, followed by the carrier layer, followed by the barrier layer, followed by the blend layer is preferred here according to the invention. The blend layer can in each case be either the first blend layer or the further blend layer.

The further blend layer can be provided at any conceivable position of the layer sequence in addition to the first blend layer. Thus the further blend layer can be provided in a layer sequence with the first blend layer followed by the carrier layer and the barrier layer, followed by the further blend layer, wherein the layers can follow one another directly and indirectly. Furthermore, the further blend layer can be provided in a layer sequence with the carrier layer, followed by the further blend layer, followed by the barrier layer, followed by the first blend layer, wherein the layers can follow one another directly and indirectly.

In a preferred embodiment of the planar composite, an additional blend layer is provided in the layer sequence. Preferably, the additional blend layer comprises a PE blend layer. Preferably, the additional blend layer is built up in exactly the same way as the first or the further blend layer. Particularly preferably, the additional blend layer comprises an LLDPE and a polyolefin which differs from LLDPE. Preferably, the additional blend layer comprises the LLDPE in a range of from at least 0.1 wt. % to 99.9 wt. %, based on the additional blend layer. As a further constituent, the additional blend layer can comprise an LDPE as a polyolefin which differs from LLDPE. Preferably, the additional blend layer has a damping factor difference in a range of from −0.3 to −0.6. Preferably, in connection with the additional blend layer this is provided with the first and the further blend layer in a planar composite according to the invention. The layer sequence comprising blend layer chosen from the group consisting of first, further and additional blend layer, followed by the carrier layer, followed by a blend layer chosen from the group consisting of first, further and additional blend layer, followed by the barrier layer, followed by a blend layer chosen from the group consisting of first, further and additional blend layer is preferred here according to the invention.

Furthermore, for example, a further layer or several further layers can also additionally be provided across an entire or part of a surface lying on the inside, that is to say on the side of the planar composite facing the barrier layer. In particular, a printed layer can also be applied on the side of the further blend layer facing the barrier layer. However, possible further layers are also covering or protective layers. According to another embodiment, it is also possible for a printed layer to be provided between the carrier layer and the first or the further blend layer. In this case, the further blend layer itself could also be a covering or protective layer for the printed layer.

The term “joined” or “composite” used in this description includes the adhesion of two objects beyond van der Waals forces of attraction. These objects can either follow one another directly or be joined to one another indirectly via further objects. For the planar composite, this means, for example, that the carrier layer can be joined directly and therefore immediately to the first blend layer, or can also be joined indirectly via an adhesion promoter layer, a direct joining being preferred. Furthermore, the further blend layer can also be joined directly and immediately to the barrier layer, but further objects, for example in the form of further polymer layers, can also be positioned in between.

The wording “comprising as a layer sequence” as used above means that at least the stated layers can be present in the planar composite according to the invention in the stated sequence. This wording does not necessarily mean that these layers follow one another directly. Furthermore, this wording also does not mean that the sequence of the layers cannot be changed. In a preferred embodiment of the planar composite, the carrier layer is followed by a further layer. This can be a blend layer, but it can also be a pure PE layer of LLDPE, LDPE, HDPE, m-PE, LDPEa or LDPEt. This wording furthermore includes constellations in which one or more additional layers can moreover be present between two layers mentioned successively in the above sequence. In a preferred embodiment of the planar composite according to the invention, the planar composite comprises a further or an additional PE layer, preferably in the same configuration as the first blend layer.

In a preferred embodiment of the planar composite, the planar composite comprises at least one first blend layer and a further blend layer or an additional blend layer, wherein these each preferably have a weight per unit area in a range of from 5 to 50 g/m², particularly preferably in a range of from 8 to 40 g/m² and most preferably in a range of from 10 to 30 g/m².

The first blend layer as well as the further, and also the additional or all further blend layers can have further constituents in addition to the constituents of the LLDPE and of the polyolefin which differs from LLDPE. The blend layer is preferably incorporated into or applied to the planar composite material in an extrusion process from a blend which comprises both LLDPE and polyolefin which differs from LLDPE, for example LDPE. The further constituents of the blend are preferably constituents which do not adversely influence the properties of the blend during application as a layer. The further constituents can be, for example, inorganic compounds, such as metal salts, or further plastics, such as further thermoplastics. However, it is also conceivable for the further constituents to be fillers or pigments, for example carbon black or metal oxides. Preferably, the blend comprises at least one further thermoplastic. Possible suitable thermoplastics for the further constituents of the first, the further or the additional blend layer are in particular those which can be easily processed due to good extrusion properties. Among these, polymers obtained by chain polymerization are suitable, in particular polyesters or polyolefins, where cyclic olefin copolymers (COC), polycyclic olefin copolymers (POC), in particular polyethylene and polypropylene, are particularly preferred and polyethylene is very particularly preferred. Among the polyethylenes, HDPE, MDPE, LDPE, LLDPE, VLDPE and PE and mixtures of at least two of these are preferred. Mixtures of at least two thermoplastics can also be employed.

According to a further preferred embodiment variant, one or more or all of the blend layers of the composite can also comprise an inorganic solid as a further constituent, in addition to a polyethylene. All solids which seem suitable to the person skilled in the art are possible as the inorganic solid, preferably particulate solids, preferably metal salts or oxides of di- to tetravalent metals. Examples which may be mentioned here are the sulphates or carbonates of calcium, barium or magnesium or titanium dioxide, preferably calcium carbonate. The average particle sizes (d50%) of the inorganic solids, determined by sieve analysis, are preferably in a range of from 0.1 to 10 μm, preferably in a range of from 0.5 to 5 μm and particularly preferably in a range of from 1 to 3 μm.

The amount of the further constituent in one of the blend layers can be in a range of from 0.1 to 40 wt. %, preferably in a range of from 0.5 to 30 wt. %, particularly preferably in a range of from 0.9 to 20 wt. %, in each case based on the blend.

The constituents of the first blend layer always add up to 100 wt. %. The constituents of the further blend layer always add up to 100 wt. %. The constituents of the additional blend layer always add up to 100 wt. %.

In a preferred embodiment of the planar composite, the polyolefin which differs from LLDPE is an LDPE; wherein the LDPE has a damping factor difference of greater than −0.4.

A planar composite wherein the LDPEa has a damping factor difference of greater than −0.4 is furthermore preferred. The LDPEt furthermore preferably has a damping factor difference of less than −0.4.

As the carrier layer, any material which is suitable for this purpose to the person skilled in the art and which has an adequate strength and rigidity to give the container stability to the extent that in the filled state the container substantially retains its shape can be employed. In addition to a number of plastics, plant-based fibrous substances, in particular celluloses, preferably sized, bleached and/or non-bleached celluloses, are preferred, paper and cardboard being particularly preferred.

In a preferred embodiment of the planar composite, the carrier layer comprises a cardboard.

The weight per unit area of the carrier layer is preferably in a range of from 120 to 450 g/m², particularly preferably in a range of from 130 to 400 g/m² and most preferably in a range of from 150 to 380 g/m². A preferred cardboard as a rule has a single- or multilayer construction and can be coated on one or both sides with one or also more covering layers. A preferred cardboard furthermore has a residual moisture content of less than 20 wt. %, preferably from 2 to 15 wt. % and particularly preferably from 4 to 10 wt. %, based on the total weight of the cardboard. A particularly preferred cardboard has a multilayer construction. The cardboard furthermore preferably has at least one, but particularly preferably at least two layers of a covering layer, which is known to the person skilled in the art as “coating”, on the surface facing the environment. In papermaking, liquid phases comprising inorganic solid particles, preferably solutions containing chalk, gypsum or clay, which are applied to the surface of the cardboard are usually called a “coating”. A preferred cardboard furthermore preferably has a Scott bond value in a range of from 100 to 360 J/m², preferably from 120 to 350 J/m² and particularly preferably from 135 to 310 J/m². By the abovementioned ranges, it is possible to provide a composite from which a container of high leakproofness can be folded easily and in low tolerances.

As the barrier layer, any material which is suitable for this purpose to the person skilled in the art and has an adequate barrier action, in particular against oxygen, can be employed. The barrier layer is preferably chosen from
i). a barrier layer of plastic;
ii). a metal layer;
iii). a metal oxide layer; or
iv). a combination of at least two of i). to iii).

If the barrier layer is a barrier layer of plastic according to alternative i)., this preferably comprises at least 70 wt. %, particularly preferably at least 80 wt. % and most preferably at least 95 wt. % of at least one plastic which is known to the person skilled in the art for this purpose, in particular because of aroma or gas barrier properties which are suitable for packaging containers. Possible plastics, in particular thermoplastics, here are N- or O-carrying plastics, both by themselves and in mixtures of two or more. According to the invention, it may prove advantageous if the barrier layer of plastic has a melting temperature (T_{p,m}) in a range of from more than 155 to 300° C., preferably in a range of from 160 to 280° C. and particularly preferably in a range of from 170 to 270° C.

Further preferably, the barrier layer of plastic has a weight per unit area in a range of from 2 to 120 g/m², preferably in a range of from 3 to 60 g/m², particularly preferably in a range of from 4 to 40 g/m² and moreover preferably from 6 to 30 g/m². Furthermore preferably, the barrier layer of plastic is obtainable from melts, for example by extrusion, in particular laminating extrusion. Moreover preferably, the barrier layer of plastic can also be introduced into the planar composite via lamination. It is preferable here for a film to be incorporated into the planar composite. According to another embodiment, barrier layers of plastic which are obtainable by deposition from a solution or dispersion of plastics can also be chosen.

Possible suitable polymers are preferably those which have a weight-average molecular weight, determined by gel permeation chromatography (GPC) by means of light scattering, in a range of from 3×10³ to 1×10⁷ g/mol, preferably in a range of from 5×10³ to 1×10⁶ g/mol and particularly preferably in a range of from 6×10³ to 1×10⁵ g/mol. Possible suitable polymers are, in particular, polyamide (PA) or polyethylene/vinyl alcohol (EVOH) or a mixture thereof.

Among the polyamides, all PA which seem suitable for the use according to the invention to the person skilled in the art are possible. PA 6, PA 6.6, PA 6.10, PA 6.12, PA 11 or PA 12 or a mixture of at least two of these are to be mentioned here in particular, PA 6 and PA 6.6 being particularly preferred and PA 6 being further preferred. PA 6 is commercially obtainable, for example, under the trade names Akulon®, Durethan® and Ultramid®. Amorphous polyamides, such as e.g. MXD6, Grivory® and Selar® PA, are moreover suitable. It is further preferable for the PA to have a density in a range of from 1.01 to 1.40 g/cm³, preferably in a range of from 1.05 to 1.30 g/cm³ and particularly preferably in a range of from 1.08 to 1.25 g/cm³. Furthermore, it is preferable for the PA to have a viscosity number in a range of from 130 to 185 ml/g and preferably in a range of from 140 to 180 ml/g.

As EVOH, all EVOH which seem suitable for the use according to the invention to the person skilled in the art are possible. Examples of these are, inter alia, commercially obtainable in a large number of different configurations under the trade name EVAL™ from EVAL Europe NV, Belgium, for example the types EVAL™ F104B or EVAL™ LR171B. Preferred EVOH have at least one, two, several or all of the following properties:
a) an ethylene content in a range of from 20 to 60 mol %, preferably from 25 to 45 mol %;
b) a density in a range of from 1.0 to 1.4 g/cm³, preferably from 1.1 to 1.3 g/cm³;
c) a melting temperature (T_{p,m}) in a range of from more than 155 to 235° C., preferably from 165 to 225° C.;
d) a melt flow rate or MFR value (210° C./2.16 kg if T_{M(EVOH)}<230° C.; 230° C./2.16 kg if 210° C.<T_{M(EVOH)}<230° C.) in a range of from 1 to 25 g/10 min, preferably from 2 to 20 g/10 min;
e) an oxygen permeation rate in a range of from 0.05 to 3.2 cm³·20 μm/m²·day·atm, preferably in a range of from 0.1 to 1 cm³·20 μm/m²·day·atm.

According to alternative ii., the barrier layer is a metal layer. All layers with metals which are known to the person skilled in the art and can provide a high impermeability to light and oxygen are suitable in principle as the metal layer. According to a preferred embodiment, the metal layer can be present as a foil or as a deposited layer, e.g. formed by a physical gas phase deposition. The metal layer is preferably an uninterrupted layer. According to a further preferred embodiment, the metal layer has a thickness in a range of from 3 to 20 μm, preferably a range of from 3.5 to 12 μm and particularly preferably in a range of from 4 to 10 μm.

Metals which are preferably chosen are aluminium, iron or copper. A steel layer, e.g. in the form of a foil, may be preferred as an iron layer. Furthermore preferably, the metal layer is a layer with aluminium. The aluminium layer can expediently be made of an aluminium alloy, for example AlFeMn, AlFe_{1.5}Mn, AlFeSi or AlFeSiMn. The purity is conventionally 97.5% and higher, preferably 98.5% and higher, in each case based on the total aluminium layer. In a particular embodiment, the metal layer is made of an aluminium foil. Suitable aluminium foils have an extensibility of more than 1%, preferably of more than 1.3% and particularly preferably of more than 1.5%, and a tensile strength of more than 30 N/mm², preferably more than 40 N/mm² and particularly preferably more than 50 N/mm². Suitable aluminium foils show a drop size of more than 3 mm, preferably more than 4 mm and particularly preferably of more than 5 mm in the pipette test. Suitable alloys for establishing aluminium layers or foils are commercially obtainable under the designations EN AW 1200, EN AW 8079 or EN AW 8111 from Hydro Aluminium Deutschland GmbH or Amcor Flexibles Singen GmbH.

In the case of a metal foil as the barrier layer, an adhesion promoter layer can be provided between the metal foil and the next blend layer or the carrier layer on one and/or both sides of the metal foil. According to a particular embodiment of the container according to the invention, however, an adhesion promoter is provided between the metal foil and the next blend layer or the carrier layer on no side of the metal foil.

Furthermore preferably, a metal oxide layer can be chosen as the barrier layer according to alternative iii. Possible metal oxide layers are all metal oxide layers which are familiar and seem suitable to the person skilled in the art for achieving a barrier action against light, vapour and/or gas. Metal oxide layers based on the metals aluminium, iron or copper already mentioned above and those metal oxide layers based on titanium or silicon oxide compounds are preferred in particular. A metal oxide layer is produced, by way of example, by vapour deposition of a metal oxide on a layer of plastic, for example an orientated polypropylene film. A preferred process for this is physical gas phase deposition.

According to a further preferred embodiment, the metal layer or metal oxide layer can be present as a laminated composite of one or more layers of plastic with a metal layer. Such a layer is obtainable, for example, by vapour deposition of a metal on a layer of plastic, for example an orientated polypropylene film. A preferred process for this is physical gas phase deposition.

In order to facilitate the ease of opening of the container according to the invention or of the planar composite, the carrier layer can have at least one hole. In a particular embodiment, the hole is covered at least with the barrier layer and at least the first blend layer as a hole-covering layer.

A planar composite wherein the carrier layer has at least one hole which is covered at least with the barrier layer and at least with the first blend layer, the further blend layer or the additional blend layer or a combination of at least two of these as a hole-covering layer is preferred.

According to a further preferred embodiment, the carrier layer of the composite has a hole which is covered at least with the first blend layer, the barrier layer and the further blend layer as hole-covering layers. It is particularly preferable for the hole additionally to be covered with the further blend layer. One or more further layers, in particular adhesion promoter layers, can furthermore be provided between the layers already mentioned. It is preferable here for the hole-covering layers to be joined to one another at least partly, preferably to the extent of at least 30%, preferably at least 70% and particularly preferably to the extent of at least 90% of the area formed by the hole. According to a particular embodiment, it is preferable for the hole to penetrate through the entire composite and to be covered by a closure or opening device which closes the hole.

In connection with a first preferred embodiment, the hole provided in the carrier layer can have any form which is known to the person skilled in the art and is suitable for various closures, drinking straws or opening aids.

The opening of a planar composite or of a container having a planar composite is usually generated by at least partial destruction of the hole-covering layers covering the hole. This destruction can be effected by cutting, pressing into the container or pulling out of the container. The destruction can be effected by an openable closure joined to the container and arranged in the region of the hole, usually above the hole, or a drinking straw which is pushed through the hole-covering layers covering the hole.

According to a further preferred embodiment, the carrier layer of the composite has a plurality of holes in the form of a perforation, the individual holes being covered at least with the barrier layer and the first blend layer as the hole-covering layer. A container produced from such a composite can then be opened by tearing along the perforation. Such holes for perforations are preferably generated by means of a laser. The use of laser beams is particularly preferred if a metal foil or a metallized foil is employed as the barrier layer. It is furthermore possible for the perforation to be introduced by mechanical perforation tools, usually having blades.

According to a further preferred embodiment, the planar composite is subjected to a heat treatment at least in the region of the at least one hole. In the case of several holes present in the carrier layer in the form of a perforation, it is particularly preferable for this heat treatment also to be carried out around the edge region of the hole.

The purpose of this heat treatment is to effect an at least partial elimination of the orientation of the polymers in the adhesive layer, in the polymer inner layer or in both layers, in particular in the hole region. This heat treatment has the effect of an improved ease of opening of the container. In the case of several holes present in the carrier layer in the form of a perforation, it is particularly preferable for this heat treatment to be carried out around the edge region of the hole.

The heat treatment can be carried out by electromagnetic radiation, by treatment with hot gas, by thermal contact with a solid, by ultrasound or by a combination of at least two of these measures.

In the case of irradiation, any type of radiation which is suitable for softening the plastics to the person skilled in the art is possible. Preferred types of radiation are IR rays, UV rays and microwaves. Preferred types of vibration are ultrasound. In the case of IR rays, which are also employed for IR welding of planar composites, wavelength ranges of from 0.7 to 5 μm are to be mentioned. Laser beams in a wavelength range of from 0.6 to less than 1.6 μm can furthermore be employed. In connection with the use of IR rays, these are generated by various suitable emitters which are known to the person skilled in the art. Short wavelength emitters in the range of from 1 to 1.6 μm are preferably halogen emitters. Medium wavelength emitters in the range of from >1.6 to 3.5 μm are, for example, metal foil emitters. Quartz emitters are often employed as long wavelength emitters in the range of >3.5 μm. Lasers are ever more often employed. Thus, diode lasers are employed in a wavelength range of from 0.8 to 1 μm, Nd:YAG lasers at about 1 μm and CO₂ lasers at about 10.6 μm. High frequency techniques with a frequency range of from 10 to 45 MHz, often in a power range of from 0.1 to 100 kW, are also employed.

In the case of ultrasound, the following treatment parameters are preferred:
P1 a frequency in a range of from 5 to 100 kHz, preferably in a range of from 10 to 50 kHz and particularly preferably in a range of from 15 to 40 kHz;
P2 an amplitude in the range of from 2 to 100 μm, preferably in a range of from 5 to 70 μm and particularly preferably in a range of from 10 to 50 μm;
P3 a vibration time (as the period of time in which a vibrating body, such as a sonotrode or inductor, acts in contact vibration on the planar composite) in a range of from 50 to 1,000 msec, preferably in a range of from 100 to 600 msec and particularly preferably in a range of from 150 to 300 msec.

For a suitable choice of the radiation or vibration conditions, it is advantageous to take into account the intrinsic resonances of the plastics and to choose frequencies close to these. Heating via contact with a solid can be effected, for example, by a heating plate or heating mould which is in direct contact with the planar composite and releases the heat to the planar composite. Hot air can be directed on to the planar composite by suitable fans, outlets or nozzles or a combination thereof. Contact heating and hot gas are often employed simultaneously. Thus, for example, a holding device which holds a tube formed from the planar composite and through which hot gas flows, and which is thereby heated up and releases the hot gas through suitable openings, can heat the planar composite by contact with the wall of the holding device and the hot gas. Furthermore, the tube can also be heated by fixing the tube with a tube holder and directing a flow from one or two and more hot gas nozzles provided in the jacket holder on to the regions of the tube to be heated.

The heat treatment can be carried out by radiation, by hot gas, by thermal contact with a solid, by mechanical vibrations or by a combination of at least two of these measures. Particularly preferably, the heat treatment is carried out by irradiation, preferably electromagnetic radiation and particularly preferably electromagnetic induction or also by hot gas. The particular optimum operating parameters to be chosen are known to the person skilled in the art.

Possible adhesion promoters in the adhesion promoter layer are all plastics which, due to functionalization by means of suitable functional groups, are suitable for generating a firm join by the formation of ionic bonds or covalent bonds to the surface of the other particular layer. Preferably, these are functionalized polyolefins which have been obtained by copolymerization of ethylene with acrylic acids, such as acrylic acid, methacrylic acid, crotonic acid, acrylates, acrylate derivatives or carboxylic acid anhydrides carrying double bonds, for example maleic anhydride, or at least two of these. Among these, polyethylene-maleic anhydride graft polymers (EMAH), ethylene/acrylic acid copolymers (EAA) or ethylene/methacrylic acid copolymers (EMAA), which are marketed, for example, under the trade names Bynel® and Nucrel®0609HSA by DuPont or Escor®6000ExCo by ExxonMobil Chemicals, are preferred. According to the invention, it is preferable for the adhesion between the carrier layer, the first blend layer, the further blend layer, the additional or the barrier layer, preferably at least two of these, and the particular next layer to be at least 0.5 N/15 mm, preferably at least 0.7 N/15 mm and particularly preferably at least 0.8 N/15 mm. In one embodiment according to the invention, it is preferable for the adhesion between the first blend layer or the further blend layer or the additional blend layer and the carrier layer to be at least 0.3 N/15 mm, preferably at least 0.5 N/15 mm and particularly preferably at least 0.7 N/15 mm. It is furthermore preferable for the adhesion between the barrier layer and the layers adjacent to the barrier layer in the case of the directly following first and/or further blend layer to be at least 0.8 N/15 mm, preferably at least 1.0 N/15 mm and particularly preferably at least 1.4 N/15 mm. In the case where the barrier layer indirectly follows the next layers of the planar composite via adhesion promoter layers, it is preferable for the adhesion between the barrier layer and the adhesion promoter layer to be at least 1.8 N/15 mm, preferably at least 2.2 N/15 mm and particularly preferably at least 2.8 N/15 mm. In a particular embodiment of the planar composite, the adhesion between the individual layers is so strong in configuration that in the adhesion test tearing of the carrier layer, and in the case of a cardboard as the carrier layer a so-called tearing of the cardboard fibre, occurs.

In one embodiment of the process according to the invention, it is preferable, for further improvement in the adhesion of two adjacent layers to one another, for these to be subjected to a surface treatment, for example, during the coating. Suitable processes for the surface treatment are a flame treatment, a treatment with plasma, a corona treatment or a treatment with ozone known, inter alia, to the person skilled in the art. However, other processes which have the effect of formation of functional groups on the surface of the treated layer are also conceivable. In a particular embodiment, at least one of these processes is used in the lamination of metal layers, in particular of metal foils.

According to a further preferred embodiment of the composite according to the invention, the planar composite according to the invention comprises at least a third layer, particularly preferably a third blend layer in the form of the additional blend layer. In a particular embodiment, the additional blend layer follows the carrier layer and preferably follows it indirectly, for example via an adhesion promoter layer. In another embodiment, more than one further layer, in particular the further blend layer, is provided between the carrier layer and the additional blend layer. If the composite according to the invention has no additional blend layer, the further blend layer follows the barrier layer, preferably indirectly, for example via an adhesion promoter layer. In another embodiment example, in the absence of the additional layer, also no further layer, in particular no adhesion promoter layer, is provided between the further blend layer and the barrier layer. It is preferable for an adhesion promoter layer to be introduced in each case between the barrier layer and the layers following on both sides, in particular the first blend layer and the further blend layer.

The third layer, in particular the third blend layer in the form of the additional blend layer, preferably has a weight per unit area in a range of from 5 to 50 g/m², particularly preferably from 8 to 40 g/m² and moreover preferably from 10 to 30 g/m². The plastics which have already been described above for the first or further blend layer, in particular, can in turn preferably be employed.

A further contribution towards achieving at least one object of the present invention is made by a process for the production of the planar composite described above. All the processes which are known to the person skilled in the art and seem suitable for the production of the composite according to the invention are possible for this. All aspects and features of the planar composite can also be applied to the process and vice versa.

The invention provides a process for the production of a planar composite, wherein the planar composite comprises a carrier layer and a barrier layer; comprising the steps:
S1. provision of a blend comprising an LLDPE;
   wherein the blend comprises the LLDPE in a range of from 10 to 99.9 wt. %, based on the blend, and
   wherein the blend has a damping factor difference in a range of from −0.3 to −0.6, preferably in a range of from −0.33 to −0.55, preferably in a range of from −0.37 to −0.54 and furthermore preferably in a range of from −0.37 to −0.425;
S2. application of the blend to a composite precursor, wherein the composite precursor comprises a carrier layer.

In process step S1. of the process according to the invention, the LLDPE is provided, as has already been described above for the planar composite.

In a preferred embodiment of the process, the blend comprises a polyolefin which differs from LLDPE.

However, the blend can also comprise any suitable compound described for the planar composite, instead of or in addition to the polyolefin which differs from LLDPE.

In a preferred embodiment of the process, the LLDPE has a damping factor difference of less than −0.4; wherein the polyolefin which differs from LLDPE is an LDPE; wherein the LDPE has a damping factor difference of greater than −0.4.

All further features of the LLDPE and of the polyolefin which differs from LLDPE can be seen from the properties stated for the planar composite.

The blend comprises the LLDPE in a range of from 10 to 99.9 wt. %, or preferably in a range of from 15 to 90 wt. %, or preferably in a range of from 20 to 80 wt. %, in each case based on the blend. The blend can comprise the polyolefin which differs from LLDPE preferably in a range of from 0.1 to 20, or preferably in a range of from 0.5 to 15 wt. %, or preferably in a range of from 1 to 10 wt. %, in each case based on the blend.

In another embodiment of the invention the blend comprises the LLDPE in a range of from 10 to 99.9 wt. %, or preferably in a range of from 40 to 99.9 wt. %, or preferably in a range of from 45 to 90 wt. %, or preferably in a range of from 50 to 80 wt.-%, in each case based on the blend. The blend can comprise the polyolefin which differs from LLDPE preferably in a range of from 0.01 to 90 wt.-%, or preferably in a range of from 0.01 to 60 wt. %, or preferably in a range of from 10 to 55 wt. %, or preferably in a range of from 20 to 50 wt.-%, in each case based on the blend.

In a second step S2., the blend from step 1. is applied to a composite precursor, wherein the composite precursor comprises a carrier layer.

The composite precursor preferably comprises the carrier layer, which can already have one or more holes. At least one printed layer can furthermore optionally be applied to the carrier layer. Preferably, however, this composite precursor is a non-printed carrier layer.

The application of this at least one blend layer is preferably carried out by melt coating, preferably by extrusion coating. However, it is also conceivable for several layers, for example further layers of plastic, barrier layers and/or adhesion promoter layers, to be applied sequentially or simultaneously by coextrusion in step S2.

In step S2., at least one further blend layer can be simultaneously or subsequently applied to the opposite side of the composite precursor. The application of this at least one further blend layer is preferably carried out by melt coating, preferably by extrusion coating. However, it is also conceivable for several layers, for example layers of plastic, barrier layers and/or adhesion promoter layers, to be applied sequentially or simultaneously by coextrusion in step S2.

During application of the individual layers, in a preferred embodiment the composite precursor is provided in the form of at least one film or of a multilayer composite film in the form of a roll, and is laminated on to the composite or composite precursor via further layers, preferably layers of plastic, preferably PE layers, particularly preferably blend layers or adhesion promoter layers. This is also the case in particular during introduction of metal layers, in particular of metal foils.

If the planar composite has one or more holes to facilitate ease of opening, these can be introduced into the composite precursor or the planar composite either before or after step S1. or after step S2.

In a preferred embodiment of the process, a non-printed-on carrier layer which already has holes is provided as the composite precursor in step S2. In step S2., the blend is then first applied to the composite precursor. In the further process step S2., the optional further blend layer, the barrier layer and optionally an additional layer or blend layer, preferably an additional blend layer, are then applied. In each case one or more adhesion promoter layers can also be co-applied here. In another embodiment, however, it is also conceivable that in step S2. first the first blend layer, the barrier layer and optionally the further blend layer are applied. Here also, in each case further layers, for example adhesion promoter layers, can be co-applied. The extrusion can be carried out in individual layers by a series of successive, individual extruders or also in multiple layers by coextrusion, the abovementioned sequence of the individual layers always being retained. A combination of extrusion and lamination coating can also take place in the process according to the invention.

In connection with the planar composite, but also in connection with the composite precursor, it is preferable for at least one of the two to have at least one or two and more scores along which edges are formed during production of the container. This facilitates the folding and the formation of a crease running along the line prepared by the score, in order to achieve in this way a fold which is as uniform and accurately positioned as possible. The scores can be introduced already before step S1. or after step S2., it being preferable for the scoring to be carried out after step S2., that is to say after the coating of the both sides of the carrier layer.

As a rule, the planar composite is produced, usually as roll goods, by coextrusion of the individual layers of the planar composite. The scores are provided on these roll goods. However, it is also possible for the scores to be produced in the carrier layer already before the coating.

The two constituents of the blend, the LLDPE and the polyolefin which differs from LLDPE, can be preheated together or separately here and then melted. Preferably, the first LLDPE and the polyolefin which differs from LLDPE are each present as granules or powder. The preheating is preferably carried out at a temperature in a range of from 30 to 100° C., preferably in a range of from 40 to 90° C. The LLDPE and the polyolefin which differs from LLDPE can then either be further melted separately, which takes place at a temperature in a range of from 130 to 150° C., or they can already be mixed before the melting.

In another embodiment of the process according to the invention, the constituents of the blend are first mixed in a temperature range of from 10 to 60° C. and the mixture obtained in this way is then melted, this preferably being carried out in an extruder.

The method of the initially mixing of the LLDPE and of the polyolefin which differs from LLDPE as granules and subsequent melting is also called the dryblend method. The method which initially provides melting of the LLDPE and of the polyolefin which differs from LLDPE, which are then brought together in the melt, is called the meltblend method.

The process wherein the provision in step 1. is effected in the melt is preferred. Preferably, the LLDPE and the polyolefin which differs from LLDPE are each present as granules or powder, which are first each brought to a temperature in a range of from 130 to 150° C., preferably in a range of from 130 to 140° C. The two melts are then brought together and mixed in an extruder. During the extrusion, the thermoplastics are conventionally heated to temperatures of from 210 to 330° C., measured on the molten polymer film below the exit at the extruder die.

The extrusion can be carried out by means of extrusion tools which are known to the person skilled in the art and commercially obtainable, such as, for example, extruders, extruder screws, feed block etc.

At the end of the extruder, there is preferably an opening, through which the blend is pressed. The opening can have any form which allows the blend to be extruded on to the composite precursor. The opening can thus be, for example, angular, oval or round. The opening preferably has the form of a slot or of a funnel. In a preferred embodiment of the process, the application is carried out through a slot. The slot preferably has a length in a range of from 0.1 to 100 m, preferably in a range of from 0.5 to 50 m, particularly preferably in a range of from 1 to 10 m. The slot furthermore preferably has a width in a range of from 0.1 to 20 mm, preferably in a range of from 0.3 to 10 mm, particularly preferably in a range of from 0.5 to 5 mm.

During the application of the blend in step S2., it is preferable for the slot and the composite precursor to move relative to one another. A process wherein the composite precursor moves relative to the slot is thus preferred.

According to a further preferred embodiment of the process according to the invention for the production of a planar composite, it is preferable, especially if the carrier layer, as described above, includes a hole or several holes, for at least one of the blends to be stretched during the application, this stretching preferably being carried out by melt stretching, very particularly preferably by monoaxial melt stretching. For this, the layer is applied in the molten state to the composite precursor by means of a melt extruder and the layer applied, which is still in the molten state, is then stretched in preferably the monoaxial direction in order to achieve an orientation of the polymer in this direction. The layer applied is then allowed to cool for the purpose of thermofixing.

In this connection, it is particularly preferable for the stretching to be carried out by at least the following application steps:
b1. emergence of the at least first blend as at least one melt film via at least one extruder die slot with an exit speed Vₑₓᵢₜ;
b2. application of the at least one melt film to the composite precursor moving relative to the at least one extruder die slot with a moving speed V_{adv};

where Vₑₓᵢₜ<V_{adv}. It is particularly preferable for V_{adv} to be greater than Vₑₓᵢₜ by a factor in the range of from 5 to 200, particularly preferably in a range of from 7 to 150, moreover preferably in a range of from 10 to 50 and most preferably in a range of from 15 to 35. In this context, it is preferable for V_{adv} to be at least 100 m/min, particularly preferably at least 200 m/min and very particularly preferably at least 350 m/min, but conventionally not to lie above 1,300 m/min.

After the melt layer has been applied to the composite precursor by means of the stretching process described above, the melt layer is allowed to cool for the purpose of thermofixing, this cooling preferably being carried out by quenching via contact with a surface which is kept at a temperature in a range of from 5 to 50° C., particularly preferably in a range of from 10 to 30° C.

As already described above, after the thermofixing it may prove to be particularly advantageous if the planar composite is heat-treated at least in the region of the at least one hole, in order to effect there an at least partial elimination of the orientation of the polymer.

According to a further preferred embodiment, at least one, preferably at least two or even all the blends are produced by extrusion or coextrusion of at least one polymer P1 through a slot die to obtain an emerging area, often also as a melt film/slip. At least one neck-in region can form on the flanks.

According to a further preferred embodiment, the area which has emerged is cooled to a temperature below the lowest melting temperature of the polymers provided in this area or its flanks, and at least the flanks of the area are then separated off from this area. Cooling can be carried out in any manner which is familiar to the person skilled in the art and seems to be suitable. The thermofixing already described above is also preferred here. At least the flanks are then separated off from the area F. The separating off can be carried out in any manner which is familiar to the person skilled in the art and seems to be suitable. Preferably, the separating off is carried out by a knife, laser beam or water jet, or a combination of two or more of these, the use of knives, in particular knives for a shear cut, being particularly preferred.

A further contribution towards achieving at least one object of the present invention is made by a planar composite obtainable by the process described above.

A further contribution towards achieving at least one object of the present invention is made by a container which surrounds an interior and comprises at least the planar composite described above. The embodiments, and in particular the preferred embodiments, described in connection with the planar composite according to the invention are also preferred for the container according to the invention.

A further contribution towards achieving at least one object of the present invention is made by a process for the production of a container which surrounds an interior and comprises at least the planar composite described above. The embodiments, and in particular the preferred embodiments, described in connection with the planar composite according to the invention are also preferred for the process for the production of the container.

A further contribution towards achieving at least one object of the present invention is made by a process for the production of a container which surrounds an interior, comprising the steps
a. provision of a planar composite according to the invention;
b. folding of the planar composite to form a fold with at least two fold surfaces adjacent to one another, the first blend layer facing away from the interior of the container;
c. joining of in each case at least a part region of the at least two fold surfaces to form a container region;
d. closing of the folded, planar composite with a closing tool.

In connection with the process according to the invention, it is preferable for the folding in step b. to be carried out in a temperature range of from 10 to 50° C., preferably in a range of from 15 to 45° C. and particularly preferably in a range of from 20 to 40° C. This can be achieved by the planar composite having a temperature in the above ranges. It is furthermore preferable for the folding tool, preferably together with the planar composite, to have a temperature in the above ranges. For this, the folding tool has no heating. Rather, the folding tool or also the planar composite or both can be cooled. It is furthermore preferable for the folding to be carried out at a temperature of at most 50° C. as “cold folding” and for the joining in step c. to be carried out at above 50° C., preferably above 80° C. and particularly preferably above 120° C. as “heat sealing”. The above conditions and in particular temperatures preferably also apply in the surroundings of the fold, for example in the housing of the folding tool. In a further embodiment of the process according to the invention, it is preferable for the cold folding or the cold folding in combination with the heat sealing to be applied at angles μ which form during folding of less than 100°, preferably less than 90°, particularly preferably less than 70° and moreover preferably less than 50°. The angle μ is formed by two adjacent fold surfaces and is illustrated in FIGS. 4a and 4b and 5a and 5b.

The process wherein the joining according to step c. is carried out by irradiation, contact with a hot solid, by mechanical vibration or hot gas or a combination of at least two of these is preferred.

The process wherein the container is filled with a foodstuff before step b. or after step c. is preferred.

The process wherein the planar composite has at least one score and the folding takes place along the score is furthermore preferred.

The plastics employed for the further layers of plastic, such as the further or the additional blend layer, can be made of a single thermoplastic or two or more thermoplastics. The above statements regarding the thermoplastics and the layers of thermoplastic therefore apply here accordingly. Generally, the plastics compositions can be fed to an extruder in any form which the person skilled in the art deems suitable for extruding. Preferably, the plastics compositions are employed as powder or granules, preferably as granules.

If the roll goods provided with scores are not employed directly in step a., container blanks for an individual container are obtained from the roll goods and are provided as the planar composite in step a.

In process step a. of the process according to the invention, a planar composite obtained by the process described above for the production of a planar composite is first provided, from which a container precursor is then formed by folding in process step b.

According to a further preferred embodiment of the process according to the invention, at least one blend layer, further preferably at least the first blend layer, or also all the blend layers has or have a melting temperature below the melting temperature of the barrier layer. This applies in particular if the barrier layer is formed from a polymer.

The melting temperatures of the at least one, preferably of the at least two blend layers and the melting temperature of the barrier layer preferably differ here by at least 1 K, particularly preferably by at least 10 K, still more preferably by at least 50 K, moreover preferably at least 100 K. The temperature difference should preferably be chosen only high enough so that no melting of the barrier layer, in particular no melting of the barrier layer of plastic, occurs during the folding.

According to the invention, in this context “folding” is understood as meaning an operation in which preferably an elongated crease forming an angle is generated in the folded planar composite by means of a folding edge of a folding tool. For this, two adjacent surfaces of a planar composite are often bent ever more towards one another. By the fold, at least two adjacent fold surfaces are formed, which can then be joined at least in part regions to form a container region. According to the invention, the joining can be effected by any measure which appears to be suitable to the person skilled in the art and which renders possible a join which is as gas- and liquid-tight as possible. The joining can be carried out by sealing or gluing or a combination of the two measures. In the case of sealing, the join is created by means of a liquid and solidification thereof. In the case of gluing, chemical bonds which create the join form between the boundary faces or surfaces of the two objects to be joined. In the case of sealing or gluing, it is often advantageous for the surfaces to be sealed or glued to be pressed together with one another.

The sealing temperature is preferably chosen such that the thermoplastic(s) involved in the sealing, preferably the polymers of the blend layers, are present as a melt. The sealing temperatures are therefore at least 1 K, preferably at least 5 K and particularly preferably at least 10 K above the melting temperature of the particular plastic. Furthermore, the sealing temperature chosen should not be too high, in order that the exposure of the plastic(s) to heat is not unnecessarily severe, so that these do not lose their envisaged material properties.

In a further preferred embodiment of the process according to the invention, it is envisaged that the container is filled with a foodstuff before step b. or after step c. All the foodstuffs for human consumption and also animal feeds known to the person skilled in the art are possible as the foodstuff. Preferred foodstuffs are liquid above 5° C., for example dairy products, soups, sauces and non-carbonated drinks. The filling can be carried out in various ways. On the one hand, the foodstuff and the container can be sterilized separately, before the filling, to the greatest degree possible by suitable measures such as treatment of the container with H₂O₂ UV radiation or other suitable high-energy radiation, plasma treatment or a combination of at least two of these, as well as heating of the foodstuff, and the container can then be filled. This type of filling is often called “aseptic filling” and is preferred according to the invention. In addition to or also instead of the aseptic filling, it is furthermore a widespread procedure to heat the container filled with foodstuff to reduce the germ count. This is preferably carried out by pasteurization or autoclaving. Less sterile foodstuffs and containers can also be employed in this procedure.

In the embodiment of the process according to the invention in which the container is filled with foodstuff before step b., it is preferable for a tubular structure with a fixed longitudinal seam first to be formed from the planar composite by sealing or gluing the overlapping borders. This tubular structure is compressed laterally, fixed and separated and formed into an open container by folding and sealing or gluing. The foodstuff here can already be filled into the container before the fixing and before the separation and folding of the base in the sense of step b.

In the embodiment of the process according to the invention in which the container is filled with foodstuff after step c., it is preferable for a container which is obtained by shaping the planar composite and is opened on one side to be employed. Shaping of the planar composite and obtaining of a container opened in which way can be carried out by steps b. and c. by any procedure which appears to be suitable for this to the person skilled in the art. In particular, shaping can be carried out by a procedure in which sheet-like container blanks which already take into account the shape of the container in their cut-out are folded such that an opened container precursor is formed. This is as a rule effected by a procedure in which after folding of this container blank, its longitudinal edges are sealed or glued to form a side wall and the one side of the container precursor is closed by folding and further fixing, in particular sealing or gluing.

In a further embodiment of the process according to the invention, it is preferable for the fold surfaces to form an angle μ of less than 90°, preferably of less than 45° and particularly preferably of less than 20°. The fold surfaces are often folded to the extent that these come to lie on one another at the end of the folding. This is advantageous in particular if the fold surfaces lying on one another are subsequently joined to one another in order to form the container base and the container top, which is often configured gable-like or also flat. Regarding the gable configuration, reference may be made by way of example to WO 90/09926 A2.

Furthermore, in one embodiment of the process according to the invention at least one of the blend layers, preferably at least the first blend layer, or also all the blend layers is or are heated above the melting temperature of the particular blend layer before step c. Preferably, before step c., particularly preferably directly before step c., heating is carried out to temperatures which are at least 1 K, preferably at least 5 K and particularly preferably at least 10 K above the melting temperature of these layers. The temperature should as far as possible be above the melting temperature of the particular plastic to the extent that by the cooling, due to the folding, moving and pressing, the plastic does not cool to the extent that this becomes solid again.

Preferably, the heating to these temperatures is carried out by irradiation, by mechanical vibrations, by contact with a hot solid or hot gas, preferably hot air, or a combination of these measures. In the case of irradiation, any type of radiation which is suitable to the person skilled in the art for softening the plastics is possible. Preferred types of radiation are IR rays, UV rays, microwaves or also electromagnetic radiation, in particular electromagnetic induction. Preferred types of vibration are ultrasound.

The invention also provides a container obtainable by the process described above.

The container according to the invention can have a large number of different forms, but a substantially square-shaped structure is preferred. The container can furthermore be formed over its complete surface from the planar composite, or can have a 2- or multi-part structure. In the case of a multi-part structure, it is conceivable that in addition to the planar composite, other materials can also be employed, for example plastic material, which can be employed in particular in the top or base regions of the container. However, it is preferable here for the container to be constructed from the planar composite to the extent of at least 50%, particularly preferably to the extent of at least 70% and moreover preferably to the extent of at least 90% of the surface. Furthermore, the container can have a device for emptying the contents. This can be formed, for example, from plastic material and attached to the outside of the container. It is also conceivable that this device is integrated into the container by “direct injection moulding”.

According to a preferred embodiment, the container according to the invention has at least one, preferably from 4 to 22 or also more edges, particularly preferably from 7 to 12 edges. In the context of the present invention, edge is understood as meaning regions which are formed on folding a surface. Edges which may be mentioned by way of example are the elongated contact regions of in each case two wall surfaces of the container. In the container, the container walls preferably represent the surfaces of the container framed by the edges.

According to the above embodiments, the invention also provides the use of the planar composite according to the invention or of a container produced therefrom or comprising this composite for storage of foodstuffs, in particular of sterilized foodstuffs.

### Test Methods:

### I. General:

Unless specified otherwise herein, the parameters mentioned herein are measured by means of ISO specifications. These are, for determination of
the MFR value for the melt flow rate: ISO 1133 (unless stated otherwise, at 190° C. and 2.16 kg);
the density: ISO 1183-1 (method C);
the melting temperature with the aid of the DSC method: DIN EN ISO 11357-1; if the sample is based on a mixture of several plastics and the determination of the melting temperature by the abovementioned method gives several peak temperatures Tₚ, the highest of the peak temperatures T_{p,m} which is to be assigned to a plastic of the plastics mixture is defined as the melting temperature. The equipment is calibrated according to the manufacturer's instructions with the aid of the following measurements:
   indium onset temperature
   heat of melting of indium
   zinc onset temperature
the molecular weight distribution by gel permeation chromatography by means of light scattering: ISO 16014-3/-5;
the viscosity number of PA: ISO 307 in 95% sulphuric acid;
the oxygen permeation rate: ISO 14663-2 annex C at 20° C. and 65% relative atmospheric humidity;
the moisture content of the cardboard: ISO 287:2009;
the Scott bond value: TAPPI T403 um;
For determination of the adhesion of two adjacent layers, these are fixed on a rotatable roll on a 90° peel test apparatus, for example from Instron “German rotating wheel fixture”, which rotates at 40 mm/min during the measurement. The samples were cut to size in 15 mm wide strips beforehand. On one side of the sample the layers are detached from one another and the detached end is clamped in a tensioning device directed perpendicularly upwards. A measuring apparatus for determining the tensile force is attached to the tensioning device. On rotation of the roll, the force necessary to separate the layers from one another is measured. This force corresponds to the adhesion of the layers to one another and is stated in N/15 mm. The separation of the individual layers can be carried out, for example, mechanically, or by a targeted pretreatment, for example by softening the sample for 3 min in 60° C. hot 30% acetic acid;
Pipette test: In this, at least 10 drops of 5 μl each of distilled water are applied to the surface to be tested and the drop size is determined.

### II. Damping Factor Difference by Means of Linear Viscoelastic Measurements

The determination of the damping factor difference is described in the following. Information on equipment, sample preparation, procedure and evaluation is provided for this.

Test Apparatus:
The shear rheology investigations were carried out on a Physica MCR 501 rotary rheometer (Anton Pan, Graz). The measurement are made with a plate-plate geometry (plate diameter 25 mm, gap 0.8 mm; type PP25/P2(19111)).

Production of the Test Specimens:
In a twin-screw extruder (Thermo Scientific Haake Rheomex OS PTW 16/25 OS diameter D: 16 mm; L/D: 25) in each case one kilogram of the materials thoroughly mixed beforehand is extruded. The following temperature profile is used here: T1=160-170° C.; T2−6=170-180° C. The speed of rotation of the screws is set at 120 revolutions per minute. After the compounding in the extruder, the melt strand is taken up on a conveyor belt and comminuted by a granulating unit. Test specimens in the form of a disc are then injection moulded from all the materials using a heated plunger injection moulding unit (Thermo Scientific Haake MiniJet II). For this, the plunger is heated to 170° C. and the cavity is heated to 50° C. The material is injected into the cavity under a pressure of 150 bar and after 10 seconds is after-pressed under 200 bar for 10 seconds. The test specimens produced have dimensions of 1.2 mm in height and 2.5 cm width.

Procedure:
The complex viscosity and the moduli (storage and loss modulus) are determined as a function of the angular frequency with frequency tests. The test specimens are conditioned at 170° C. for 4 min in the rheometer before the measurement starts. The frequency tests are carried out at between 125-0.06 rads (20-0.01 Hz) with a deformation amplitude of γ=5%. Within this range, 11 measurement points are recorded at 170° C. in the linear viscoelastic range. A triplicate determination is performed for each specimen.

Calculation of the Damping Factor Difference:

Storage Modulus G′ and Loss Modulus G″:

$$Storage modulus {G}^{′} = \frac{2 h {M}_{Real}}{π {R}^{4}}$$

$$Loss modulus {G}^{″} = \frac{2 h {M}_{Imag}}{π {R}^{4}}$$

$$Damping factor δ = arctan \frac{{G}^{″}}{{G}^{′}}$$

Damping Factor Difference (Between 0.01 and 0.1 Hz):

$$Damping factor difference = \frac{{log ( tan δ )}_{{f}^{″}} - {log ( tan δ )}_{{f}^{′}}}{log {f}^{″} - log {f}^{′}} = {log ( tan δ )}_{{f}^{″} = 0.1 Hz} - {log ( tan δ )}_{{f}^{′} = 0.01 Hz}$$

### III. Determination of the Elongation at Break of Bodies of Plastic: EN ISO 527-Part 1 to 3

Supplementary to the above EN ISO:

Test Apparatus:
TIRAtest TT27025 (TIRA GmbH; D-96528 Schalkau)
   Test specification: Tensile test plastics EN ISO 527

Test Specimens:
The form of the test specimens for the determination of the elongation at break is a strip which is 15 mm wide and no shorter than 90 mm.

Production of the Test Specimens:
The laminate is separated in the cardboard layer. The inner layer of the laminate which has been separated off is laid in a 30% acetic acid bath at 60° C. for 15 min. The laminate is covered completely. The polyethylene inner film and the polyethylene laminating film are then detached under running water. Both are to be dried thoroughly. The outer film is laid in ethyl acetate for one minute. The detachment is then carried out. The test specimens described are cut or stamped out such that the edges are smooth and free from notches; it is advisable to check the absence of notches under a low magnification. At least five test specimens must be tested in each test direction required.

Test Parameters:
Initial length L=40 mm (determined between the clamps)
Width b=15 mm
Test speed V₀=20 mm/min (until the pre-load F₀ is reached)
   V₁=100 mm/min (measurement)
Pre-load F₀=0.1 N
Elongation at break last recorded elongation value before a drop in stress to less than or equal to 10% of the strength value takes place

Calculation of the Elongation Factor (%)

$$Yield factor = 10 \{ \frac{log ( elongation at break MD ) + log ( elongation at break CD )}{2} \}$$

MD: machine direction; CD: cross direction

### IV. Maximum Draw-Down Ratio

The greatest acceleration of the melt slip between the die opening and substrate before the film tears; calculated from the ratio of the distance between the die lips (here: 0.6 mm) and the thickness of the coated film. The higher the value, the more quickly a plastic can be coated in a stable manner.

$$Draw \text{-} down ratio = \frac{a}{b}$$

where: a=die gap [mm]; b=film thickness on the substrate [mm];

### V. Neck-in

Constriction of the film width between the die opening and the substrate on each side of the film; calculated from the difference between the die width and the film width on the substrate. The lower the value, the more easily wide cardboard rolls can be coated, and the production unit can be utilized more effectively. For determination of the neck-in, the width of the film on the substrate is measured and the calculation is performed with the following formula:

$$N eck \text{-} in ( mm ) = \frac{a - b}{2}$$

where: a=die width [mm]; b=film width on the substrate [mm].

### EXAMPLES

The planar composites were produced with the aid of the coating process described above according to process steps S1.-S2. According to step S1., 70 wt. % of LLDPE granules (Ineos Eltex LL2640AC having a damping factor difference of −0.542, commercially obtainable from Ineos GmbH, Cologne, D) and 30 wt. % of LDPE granules (Ineos 23L430 having a damping factor difference of −0.326, commercially obtainable from Ineos GmbH, Cologne, D) are provided. The granules are mixed in a drum mixer at room temperature according to step S2. and fed to a screw extruder. For the planar composite according to Example 1, a carrier layer optionally having holes for closures or drinking straws is then initially laid down, on to which the blend from step S1. is applied according to step S2. This is carried out in a commercially available coating unit, on which the further layers listed in the following Table 1 were also generated.

TABLE 1
Composition of a container according to the invention

| | |
|---|---|
| Example 1 | Weight per unit area |

| | | | |
|---|---|---|---|
| PE blend | 15 | g/m² | (3) |
| Carrier | 210 | g/cm² | (2) |
| PE blend | 18 | g/m² | (3) |
| Adhesion promoter | 2 | g/m² | (6) |
| Barrier | 6 | μm | (1) |
| Adhesion promoter | 4 | g/m² | (5) |
| PE blend | 22 | g/m² | (3) |
| mPE blend | 10 | g/m² | (4) |

(1) Aluminium, EN AW 8079, thickness = 6 μm from Hydro Aluminium Deutschland GmbH
(2) Cardboard: Stora Enso Natura T Duplex Doppelstrich, Scott bond 200 J/m², residual moisture content 7.5%
(3) LLDPE/LDPE 70/30 blend - prepared as described above
(4) m-PE blend: 30 wt. % of Affinity ® PT 1451G1 from Dow Chemicals and 70 wt. % of LDPE 19N430 from Ineos GmbH, Cologne
(5) Escor 6000 HSC Exxonmobil
(6) Novex M21N430 from Ineos GmbH, Cologne

The blend layer according to the invention designated (3) in Example 1 and having a content of 70 wt. % of LLDPE and 30 wt. % of LDPE has the properties shown in Table 2:

TABLE 2
Properties of a PE blend according to the invention

| Properties | LLDPE/LDPE 70/30 |
|---|---|
| Damping factor difference [—] | −0.388 |
| Melt flow rate MFR [g/10 min] | 4.1 |
| Peak temperature Tₘ [° C.] | 125 |
| Density [g/cm³] | 0.928 |
| Average molecular weight M_{w} | 2.1*10⁵ g/mol |
| Olefin content | 4.6 wt. %, based on the total weight |

In the studies, described in the following, on various blend layers in Tables 2 to 8, for the blend layers as the LLDPE content always one of LLDPE 1 granules (having a damping factor difference of −0.542, commercially obtainable from Ineos GmbH, Cologne, D) and LLDPE 2 granules (having a damping factor difference of −0.476, commercially obtainable from Sabic BV, Geleen, NL); and as a further component, up to a total of 100 wt. %, LDPE granules (Ineos 23L430 having a damping factor difference of −0.326, commercially obtainable from Ineos GmbH, Cologne, D) were used. There were no further constituents of the blend layer in these examples. The results from the draw-down tests are shown in Table 3.

TABLE 3
Draw-down ratios of various PE blends

| | | Draw-down ratio | Draw-down ratio |
|---|---|---|---|
| LLDPE 1 or 2 | LDPE | LLDPE 1 | LLDPE 2 |
| wt. % in | wt. % in | (Ineos ® | (Sabic ® |
| the blend | the blend | LL2640AC) | LLDPE 318B) |
| 100 | 0 | 565 | 535 |
| 80 | 20 | 451 | 477 |
| 65 | 35 | 315 | 344 |
| 50 | 50 | 185 | 199 |
| 0 | 100 | 101 | 101 |

A combination of a PE having a Δ damping factor of >−0.4 and a PE having a Δ damping factor of <−0.4 brings advantages in the production of planar composites, as can also be seen from FIG. 10. This holds in particular for LLDPE contents of 50 wt-% or more based on the blend.

FIG. 10 shows that in a mixture with 50 and more wt. % of LLDPE, a significantly higher DDR is obtained than when a pure LDPE is used. This allows a higher coating speed.

The results from the neck-in test are shown in Table 4.

TABLE 4
Neck-in ratios of various PE blends

| LLDPE 1 or 2 | LDPE | | |
|---|---|---|---|
| wt. % in | wt. % in | Neck-in in mm | Neck-in in mm |
| the blend | the blend | LLDPE 1 | LLDPE 2 |
| 100 | 0 | approx. 165; | approx. 165; |
| | | with film | with film |
| | | width variations | width variations |
| 90 | 10 | 89 | 90 |
| 80 | 20 | 80 | 82 |
| 70 | 30 | 70 | 75 |
| 60 | 40 | 65 | 70 |
| 0 | 100 | 55 | 55 |

As can be seen from Table 4, the neck-in properties of the pure LLDPE is very high and furthermore combined with wide variations in film width. It has been found, surprisingly, that significantly lower neck-in properties can already be achieved by small amounts of LDPE, e.g. 10 wt. % in a PE blend of LLDPE and LDPE. It is striking in this context that the neck-in value of the mixtures of LLDPE and LDPE does not correspond to the mean of the neck-in values of the two components LLDPE and LDPE, as would be presumed (in particular in the range of the content of LLDPE between 70% and 100%, very specifically between 80% and 100%). This particular behaviour is also shown in the form of a graph in FIG. 8, and manifests itself in a non-linear behaviour of the neck-in values at various mixing ratios of LLDPE and LDPE.

The interaction between the DDR and the neck-in is shown in Table 5. At a content of from 50 to 80 wt. % of LLDPE, a PE blend with particularly good processing properties is obtained.

TABLE 5
Effects of the draw-down ratios and
the neck-in on the extrusion process.

| | Content of LLDPE 1 or LLDPE 2 | | | |
|---|---|---|---|---|
| | 0 wt. % | 50 wt. % | 80 wt. % | 100 wt. % |
| Film width variation | + | + | + | − |
| Draw-down ratio | − | + | + | ++ |
| Neck-in | + | + | + | − |
| Overall result | + | ++ | ++ | − |

A combination of an LLDPE having a damping factor difference of <−0.4 and an LDPE having a damping factor difference of >−0.4 brings additional advantages for the packaging container itself, in addition to the improved processing properties. These can be seen from Table 6, where the elongation at break of various PE blends is shown.

TABLE 6
Yield properties of PE blends having a varying content of LLDPE.

| LLDPE 1 or | Coating | Elongation | Elongation | Elongation |
|---|---|---|---|---|
| LLDPE 2 | weight | at break | at break | factor |
| wt. % in the blend | g/m² | in % MD | in % CD | in % |
| 0 | 20 | 167 | 167 | 167 |
| 10 | 20 | 248 | 267 | 257 |
| 70 | 20 | 583 | 677 | 628 |

At a content of from 10 to 70 wt. % of LLDPE in the PE blend, a significantly improved elongation factor is found. Planar composites comprising such PE blends can therefore be folded significantly better and at lower temperatures. Furthermore, the packaging containers produced in this way show an improved leakproofness. This applies in particular to the regions of the container which are folded at an angle μ, described in more detail in FIGS. 4a, 4b and 5a, 5b, of 100°.

TABLE 7
Puncture properties as well as breaking strength and tear propagation
capacity of PE blends having a varying content of LLDPE.

| LLDPE 1 or | Coating | | | Tear |
|---|---|---|---|---|
| LLDPE 2 | weight | Puncture | Breaking | propagation |
| wt. % in the blend | g/m² | resistance | strength | capacity |
| 0 | 20 | − | − | − |
| 10 | 20 | + | + | + |
| 70 | 20 | ++ | ++ | ++ |

Further properties of the planar composite according to the invention are shown in Table 7. It is thus found that by the amount according to the invention of at least 10 wt. % of LLDPE in the blend layer a higher puncture resistance, an increased breaking strength and a reduced tear propagation capacity can be achieved compared with blend layers without LLDPE.

TABLE 8
Puncture properties

| Δ damping | | | | | Tear |
|---|---|---|---|---|---|
| factor of | Neck- | Elongation | Puncture | Breaking | propagation |
| the PE blend | in | factor | resistance | strength | capacity |
| <−0.4 | + | ++ | ++ | ++ | ++ |
| >−0.4 | ++ | + | + | + | + |

The properties for PE blends with a mixture according to the invention of 75 wt. % of either LLDPE 1 or LLDPE 2, and 25 wt. % of LDPE are shown in Table 8. It can be seen here that the mixture having a damping factor difference of less than −0.4, that is to say having a higher LLDPE content, has improved properties as regards the elongation factor, the puncture resistance, the breaking strength and the tear propagation capacity.

On the basis of the improved elongation properties and the increased puncture resistance, the increased breaking strength and the reduced tear propagation capacity, by embodiment employing blend layers having a content according to the invention of at least 10 wt. % of LLDPE improved planar composites for e.g. cardboard packaging in the foodstuffs packaging field can be provided. The risk of an unwanted tearing in of the planar composite can be minimized in this way. In addition, due to the improved elongation properties and the increased breaking strength, the thickness of the blend layer and therefore also of the planar composite can be optimized and lowered compared with conventional blend layers, which leads both to a lowering of production costs and to a reduction in the weight of the packaging produced from the planar composite according to the invention.

### Further Examples

The planar composite of the further example 1 was produced with the aid of the coating process described above according to process steps S1.-S2. According to step S1., 70 wt. % of LLDPE 2 granules (Sabic LLDPE 318B having a damping factor difference of −0.476, commercially obtainable from Sabic BV, Geleen, NL) and 30 wt. % of LDPE granules (Ineos 23L430 having a damping factor difference of −0.326, commercially obtainable from Ineos GmbH, Cologne, D) are provided. The granules are mixed in a drum mixer at room temperature according to step S2. and fed to a screw extruder. For the planar composite according to further example 1, a carrier layer optionally having holes for closures or drinking straws is then initially laid down, on to which the blend from step S1. is applied according to step S2. This is carried out in a commercially available coating unit, on which the further layers listed in the following Table 9 were also generated.

TABLE 9
Composition of a container according to the invention

| | |
|---|---|
| Further example 1 | Weight per unit area |

| | | | |
|---|---|---|---|
| PE-Blend | 15 | g/m² | (3) |
| Carrier | 210 | g/cm² | (2) |
| PE-Blend | 18 | g/m² | (3) |
| Adhesion promoter | 2 | g/m² | (6) |
| Barrier | 6 | μm | (1) |
| Adhesion promoter | 4 | g/m² | (5) |
| PE-Blend | 22 | g/m² | (3) |
| mPE blend | 10 | g/m² | (4) |

(1) Aluminium, EN AW 8079, thickness = 6 μm from Hydro Aluminium Deutschland GmbH
(2) Cardboard: Stora Enso Natura T Duplex Doppelstrich, Scott bond 200 J/m², residual moisture content 7.5%
(3) LLDPE 2/LDPE 70/30 blend - prepared as described above
(4) m-PE blend: 30 wt. % of Affinity ® PT 1451G1 from Dow Chemicals and 70 wt. % of LDPE 19N430 from Ineos GmbH, Cologne
(5) Escor 6000 HSC Exxonmobil
(6) Novex M21N430 from Ineos GmbH, Cologne

The blend layer according to the invention designated (3) in further example 1 and having a content of 70 wt. % of LLDPE 2 and 30 wt. % of LDPE has the properties shown in Table 10:

TABLE 10
Properties of a PE blend according to the invention

| Properties | LLDPE 1/LDPE 70/30 |
|---|---|
| Damping factor difference [—] | −0.364 |
| Melt flow rate MFR [g/10 min] | 2.4 |
| Peak temperature Tₘ [° C.] | 121 |
| Density [g/cm³] | 0.921 |
| Average molecular weight M_{w} | 4.5*10⁵ g/mol |
| Olefin content | 4.6 wt. %, based on the total weight |

For each of the studies presented in the following Tables 11 to 13 one selected from the group consisting of the LLDPE 1 to 5 as given in List 1 was blended with the LDPE Ineos 23L430 in different ratios. Therein the blends comprise the LDPE in an amount which is the remainder up to 100 wt.-%. The damping factor differences of the LDPE 1 to 5 given in List 1 pertain the pure LLDPE 1 to 5. The LLDPE 2 and the LLDPE 3 are commercially obtainable from Sabic BV, Geleen, NL. The LLDPE 1 and the LLDPE 5 are commercially obtainable from Ineos GmbH, Cologne, D. The LLDPE 4 is commercially obtainable from ExxonMobil Chemical Central Europe, Cologne, D. In the case of a planar composite in the following studies this was produced as given above for further example 1.

List 1

| | Damping factor |
|---|---|
| LLDPE | difference [—] |

| | | |
|---|---|---|
| LLDPE 1 | Ineos LL2640AC | −0.542 |
| LLDPE 2 | Sabic LLDPE 318B | −0.476 |
| LLDPE 3 | Sabic R40039E | −0.564 |
| LLDPE 4 | Exxonmobile LLDPE LL1004YB | −0.533 |
| LLDPE 5 | Ineos LL2635UA | −0.405 |

Results of draw-down tests and neck-in tests applying the LLDPE 1 to 5 as provided in List 1 in different amounts are shown in Tables 11 and 12.

TABLE 11
Draw-down ratios of various PE blends

| LLDPE | Max. draw- | Max. draw- | Max. draw- | Max. draw- | Max. draw- |
|---|---|---|---|---|---|
| wt. % in | down ratio | down ratio | down ratio | down ratio | down ratio |
| PE blend | LLDPE 1 | LLDPE 2 | LLDPE 3 | LLDPE 4 | LLDPE 5 |
| 100 | 565 | 535 | 745 | 650 | 517 |
| 80 | 451 | 477 | 553 | 528 | 443 |
| 65 | 315 | 344 | 409 | 387 | 311 |
| 50 | 185 | 199 | 243 | 235 | 186 |
| 0 | 101 | 101 | 101 | 101 | 101 |

A combination of a LDPE having a Δ damping factor of >−0.4 and a LLDPE having a Δ damping factor of <−0.4 brings advantages in the production of planar composites as can be concluded from Table 11. Accordingly, in a mixture with 50 and more wt. % of LLDPE, a significantly higher DDR is obtained than when a pure LDPE is used. This allows a higher coating speed, i.e. in the production of planar composites.

The results from the neck-in test are shown in Table 12.

TABLE 12
Neck-in ratios of various PE blends

| LLDPE | Neck-in | Neck-in | Neck-in | Neck-in | Neck-in |
|---|---|---|---|---|---|
| wt. % in | in mm | in mm | in mm | in mm | in mm |
| PE blend | LLDPE 1 | LLDPE 2 | LLDPE 3 | LLDPE 4 | LLDPE 5 |
| 0 | 55 | 55 | 55 | 55 | 55 |
| 60 | 65 | 70 | 66 | 68 | 66 |
| 70 | 70 | 75 | 69 | 73 | 71 |
| 80 | 80 | 82 | 80 | 83 | 81 |
| 90 | 89 | 90 | 90 | 93 | 89 |
| 100 | averaged | averaged | averaged | averaged | averaged |
| | ca. 165 | ca. 165 | ca. 167 | ca. 172 | ca. 165 |

As can be seen from Table 12, the neck-in properties of the pure LLDPE are very high and furthermore combined with wide variations in film width. It has been found, surprisingly, that significantly lower neck-in properties can already be achieved by small amounts of LDPE, e.g. 10 wt. % in a PE blend of LLDPE and LDPE. It is striking in this context that the neck-in value of the mixtures of LLDPE and LDPE does not correspond to the mean of the neck-in values of the two components LLDPE and LDPE, as would be presumed (in particular in the range of the content of LLDPE between 70% and 100%, very specifically between 80% and 100%). This particular behaviour manifests itself in a non-linear behaviour of the neck-in values at various mixing ratios of LLDPE and LDPE.

The interaction between the DDR and the neck-in is shown in Table 13. At a content of from 50 to 80 wt. % of LLDPE (here in each case one of LLDPE 1 to 4), a PE blend with particularly good processing properties is obtained.

TABLE 13
Effects of the draw-down ratios and
the neck-in on the extrusion process.

| | Content of one of LLDPE 1 to 4 | | | |
|---|---|---|---|---|
| | 0 wt. % | 50 wt. % | 80 wt. % | 100 wt. % |
| Film width variation | + | + | + | − |
| Draw-down ratio | − | + | + | ++ |
| Neck-in | + | + | + | − |
| Overall result | + | ++ | ++ | − |

In the studies of various blend layers summarized in the Tables 14 and 15 for each blend layer the LLDPE 2 granule (Sabic LLDPE 318B commercially available from Sabic BV, Geleen, NL having a damping factor difference of −0.476) and as a further component completing the sum to 100 wt. %, based on the total weight of the blend layer, the LDPE granule (Ineos 23L430 commercially available from Ineos GmbH, Köln, D having a damping factor difference of −0.326) were applied. There were no further components of the blend layer in these examples. A combination of an LLDPE having a damping factor difference of <−0.4 and to an LDPE having a damping factor difference of >−0.4 brings additional advantages for the packaging container itself, in addition to the improved processing properties. These can be seen from Table 14, where the elongation at break of various PE blends is shown.

TABLE 14
Yield properties of PE blends having a varying content of LLDPE.

| LLDPE 2 | Coating | Elongation | Elongation | Elongation |
|---|---|---|---|---|
| wt. % in | weight | at break | at break | factor |
| the blend | g/m² | in % MD | in % CD | in % |
| 0 | 20 | 167 | 167 | 167 |
| 10 | 20 | 261 | 272 | 248 |
| 70 | 20 | 595 | 660 | 631 |

At a content of from 10 to 70 wt. % of LLDPE in the PE blend, a significantly improved elongation factor and elongation at break are found. Planar composites comprising such PE blends can therefore be folded significantly better and at lower temperatures. Furthermore, the packaging containers produced in this way show an improved leakproofness. This applies in particular to the regions of the container which are folded at an angle μ, described in more detail in FIGS. 4a, 4b and 5a, 5b, of 100°.

TABLE 15
Puncture properties as well as breaking strength and tear propagation
capacity of PE blends having a varying content of LLDPE.

| LLDPE 2 | Coating | | | Tear |
|---|---|---|---|---|
| wt. % in | weight | Puncture | Breaking | propagation |
| the blend | g/m² | resistance | strength | capacity |
| 0 | 20 | − | − | − |
| 10 | 20 | + | + | + |
| 70 | 20 | ++ | ++ | ++ |

Further properties of the planar composite according to the invention are shown in Table 15. It is thus found that by the amount according to the invention of at least 10 wt. % of LLDPE in the blend layer a higher puncture resistance, an increased breaking strength and a reduced tear propagation capacity can be achieved compared with blend layers without LLDPE.

In the studies of various blend layers summarized in the Table 16 for each blend layer one of the LLDPE 2 to 5, and as a further component completing the sum to 100 wt. %, based on the total weight of the blend layer, the LDPE granule (Ineos 23L430 commercially available from Ineos GmbH, Köln, D having a damping factor difference of −0.326) were applied. There were no further components of the blend layer in these examples.

TABLE 16
Puncture properties of blend layers

| LLDPE | | | | Punc- | | Tear |
|---|---|---|---|---|---|---|
| wt. % | Δ damping | | Elonga- | ture | Break- | propa- |
| based on | factor of the | Neck- | tion | resis- | ing | gation |
| blend layer | PE blend | in | factor | tance | strength | capacity |
| 70 | −0.521* | −− | ++ | ++ | ++ | ++ |
| of LLDPE 3 | | | | | | |
| 60 | −0.431* | + | ++ | ++ | ++ | ++ |
| of LLDPE 4 | | | | | | |
| 70 | −0.364* | ++ | + | + | + | + |
| of LLDPE 2 | | | | | | |
| 15 | −0.283^{#} | + | − | − | − | − |
| of LLDPE 5 | | | | | | |

(*according to the invention; ^{#}not according to the invention)

The properties for PE blends with a mixture according to the invention of LLDPE 2 and the LDPE Ineos 23L430; of LLDPE 3 and the LDPE Ineos 23L430, LDPE; and of LLDPE 4 and the LDPE Ineos 23L430 are shown in Table 16. The PE blend containing a mixture of LLDPE 5 and the LDPE Ineos 23L430 is not according to the invention. The corresponding LLDPE contents for each example are given in Table 16. It can be seen here that the mixture having a damping factor difference in the range of from −0.3 to −0.6 (rows 2 to 4 of Table 16) has improved properties as regards the elongation factor, the puncture resistance, the breaking strength and the tear propagation capacity. Moreover, it can be seen here that a mixture having a damping factor difference in the range of from −0.3 to −0.6 and of less than −0.4 (rows 2 and 3 of Table 16) has even more improved properties as regards the elongation factor, the puncture resistance, the breaking strength and the tear propagation capacity.

On the basis of the improved elongation properties and the increased puncture resistance, the increased breaking strength and the reduced tear propagation capacity, by embodiment employing blend layers having a content according to the invention of at least 10 wt. % of LLDPE improved planar composites for e.g. cardboard packaging in the foodstuffs packaging field can be provided. The risk of an unwanted tearing in of the planar composite can be minimized in this way. In addition, due to the improved elongation properties and the increased breaking strength, the thickness of the blend layer and therefore also of the planar composite can be optimized and lowered compared with conventional blend layers, which leads both to a lowering of production costs and to a reduction in the weight of the packaging produced from the planar composite according to the invention.

### FIGURES

The present invention is now explained in more detail by these drawings given by way of example which do not limit it, the figures showing

1 a diagram of a container produced by the process according to the invention,

2 a process flow diagram of the process according to the invention,

3 a diagram of a region of a container to be produced by the process according to the invention,

4a a diagram of folding by the process according to the invention,

4b a diagram of a fold by the process according to the invention,

5a a diagram along a section A-A in the unfolded state,

5b a diagram along a section A-A in the folded state,

6 a diagram of a planar composite which can be employed in the process according to the invention,

7a extrusion process (plan view),

7b extrusion process (side view),

8 a diagram of the neck-in behaviour of PE blends with varying LLDPE contents,

9 a diagram of the damping factor differences of PE blends with varying LLDPE 1 contents,

10 a diagram of the maximum draw-down ratios of PE blends with varying LLDPE contents.

FIG. 1 shows a container 2 surrounding an interior 1 and made of a planar composite 3. The container 2 is shown with the container upper side 12 facing upwards. The container 2 is made of the planar composite 3 which includes at least the carrier layer 4. The container 2 can furthermore include a hole in the form of an opening or perforation 36.

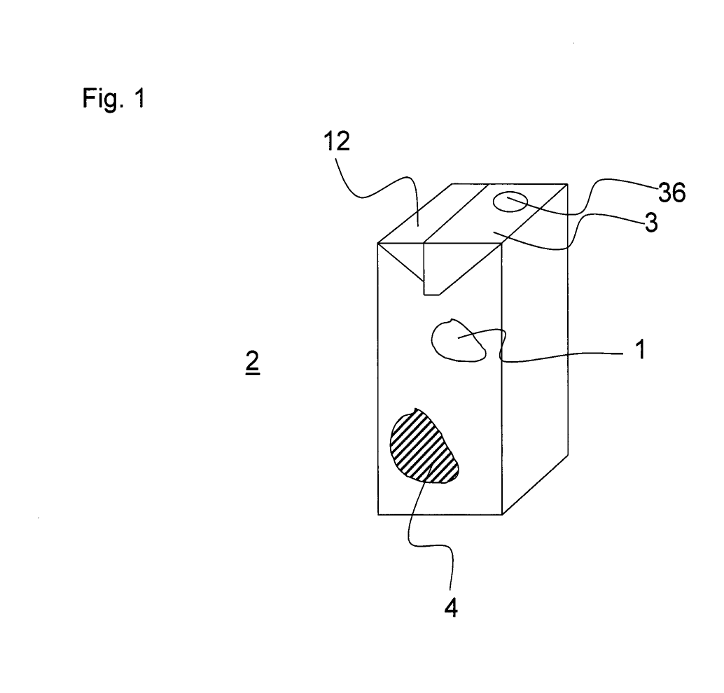

FIG. 2 shows a flow diagram of devices and production steps by the process according to the invention. In a first step S0., the blend step 20, an LLDPE having a damping factor difference of less than −0.4 and an LDPE having a damping factor difference of greater than −0.4 are thus brought together as a dryblend. In this case, this step S0. is carried out in each case in the form of dry granules of the LLDPE and the LDPE. In this blend step 20 the LLDPE and the LDPE are mixed in a drum mixer in a ratio of 7:3. The thermoplastic is then provided in the form of the blend in a provision step 21. In the following application step 22, the blend is applied as the first blend layer 13 or further blend layer 35 to the composite precursor 45. In this example the composite precursor 45 comprises at least the carrier layer 4. This application step 22 can be followed by further steps in succession or at the same time. This can be, for example, the application of a further blend layer as well as the application of the barrier layer 5, for example in the form of an aluminium layer. This can be followed in turn by a container production, in which in particular the folding and joining are carried out. Filling with a foodstuff can also be carried out here.

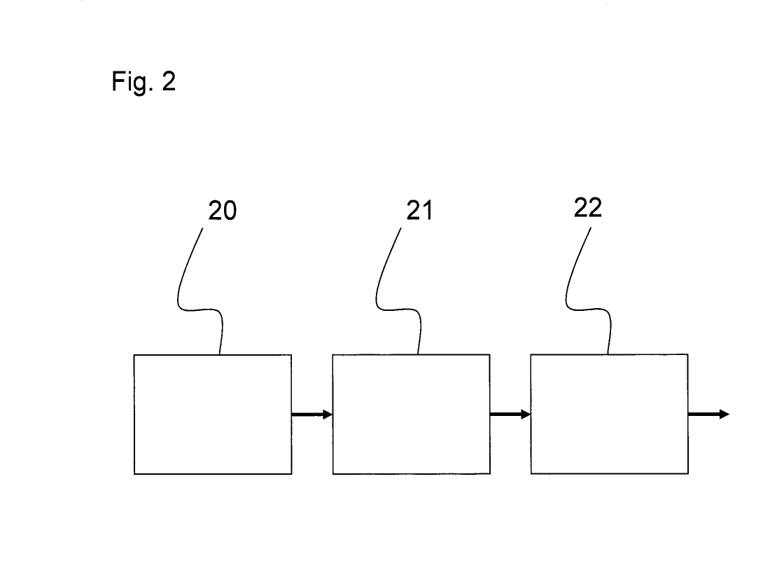

FIG. 3 shows a container 2 formed during the process according to the invention, which—for a better view—is shown with a container region 23 envisaged for a base 12 on the top. The container region 23 envisaged for the base 12 has a plurality of scores 14.

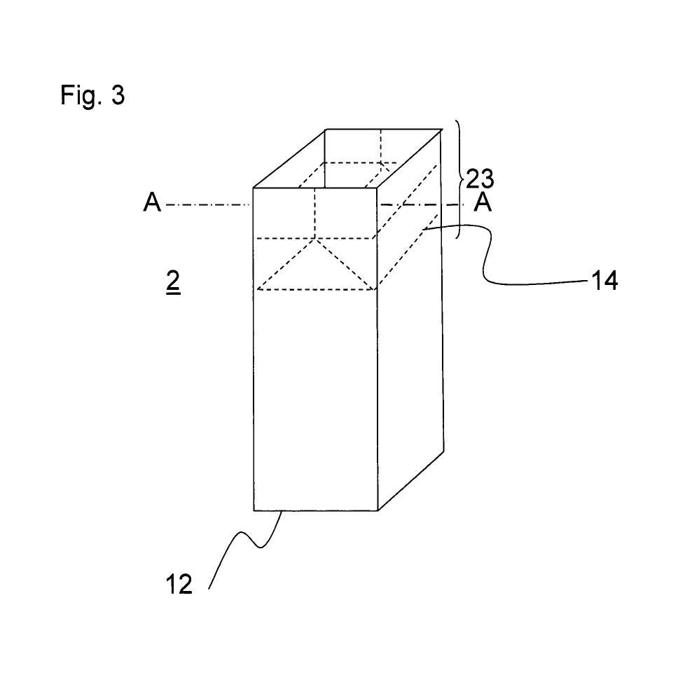

FIG. 4a shows the cross-section through a planar composite 3 with a score 14, formed by a recess 24 and a bulge 25. An edge 17 of a folding tool 18 is provided above the recess 24, in order to engage in the recess 24, so that folding, preferably in a temperature range of from 10 to 50° C., can be carried out around the edge 17 along the score 14, in order to obtain a fold 8 shown as a cross-section in FIG. 4b. This fold 8 has two fold surfaces 9 and 10 which enclose an angle μ and are present as a part 15 of large area and a part 16 of small area. At least one layer of thermoplastic in the form of the blend layers 13, 35 or 7 is melted in a part region 11 of the part 16 of small area. By pressing the fold surfaces 9, 10 together, reducing the angle μ to 0, the two fold surfaces 9, 10 are joined to one another by sealing.

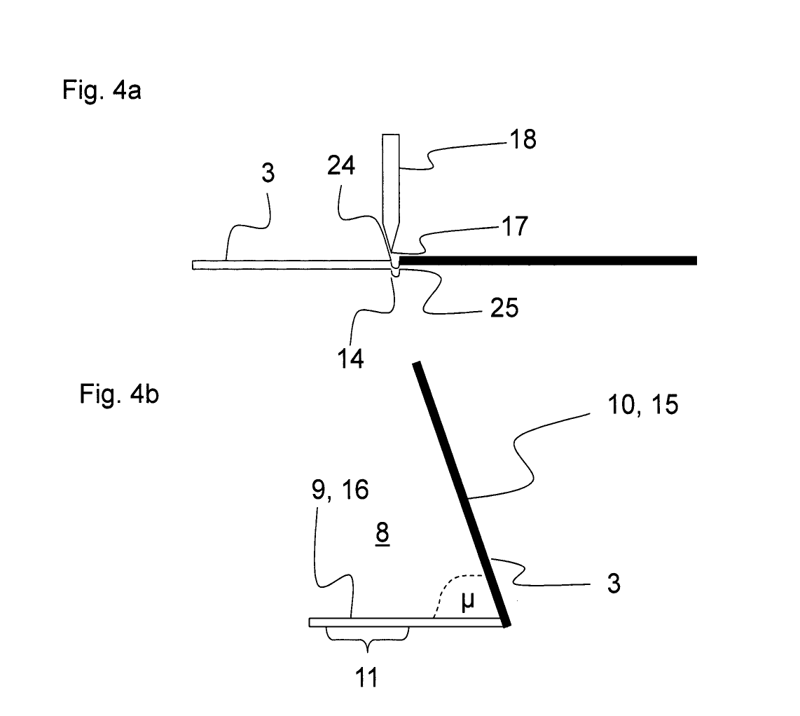

FIG. 5a shows a section along the line A-A in FIG. 3, before folding, from a planar composite 3 with scores 14. By edges 17 of folding tools 18 which engage in the scores 14 installed centrally on the front faces, the scores 14 are moved in the direction of the two arrows, as a result of which the folds 8 shown in FIG. 5b with the angles μ are formed, preferably in a temperature range of from 10 to 50° C. The section shown here through the outermost part to be folded of the container region envisaged for the base 12 of the container 2 has a part region 11 towards the interior 1 in which at least one layer of thermoplastic 13, 35 or 7 is melted. By pressing together the longitudinal sides 26, reducing the six angles μ to 0°, the two inner surfaces 27 of the longitudinal sides 26 facing the interior 1 are joined to one another by sealing, in order thus to create the base 12.

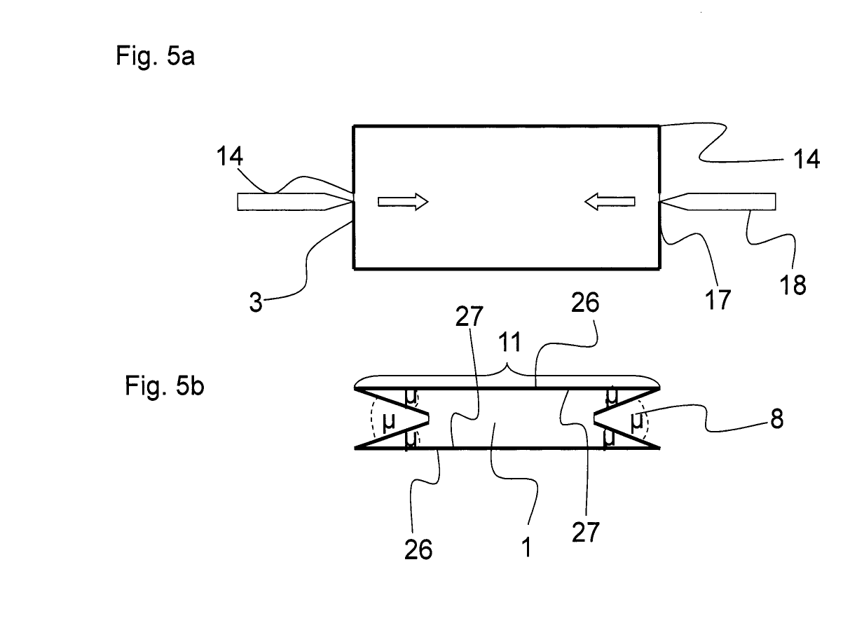

FIG. 6 shows a planar composite 3, the upper side lying on the outside in the container 2 produced therefrom and the under-side facing the interior 1, that is to say lying on the inside. The following construction from the outside inwards results: first blend layer 13 (e.g. 30 wt. % of LDPE granules (having a damping factor difference of −0.326, commercially obtainable from SABIC Europe BV) and 70 wt. % of LLDPE granules (having a damping factor difference of −0.542, commercially obtainable from Ineos GmbH, Cologne) having a weight per unit area in a range of from 8 to 60 g/m², followed by a carrier layer 4 of the cardboard in Table 1 having a weight per unit area in a range of from 120 to 400 g/m², followed by a further blend layer 35, which is built up in exactly the same way as the blend layer 13, usually having a weight per unit area in a range of from 5 to 50 g/m², followed by a layer of adhesion promoter as in Table 1 having a weight per unit area in a range of from 2 to 30 g/m², followed by a barrier layer 5, for example an aluminium foil having a thickness of 6 μm, as in Table 1, optionally followed by an adhesion promoter layer 6, as in Table 1, optionally followed by an additional PE layer 7 having a weight per unit area in a range of from 2 to 60 g/m². Finally, a further PE layer 46 can also be present, comprising an mPE blend 30/70 (cf. Table 1). The planar composite 3 shown here can preferably be produced by the process described in FIG. 2 with simultaneous extrusion, called coextrusion, of layers 35 and 19. Some or all of the other layers 5, 6, 7 or 46 can also be extruded in succession or applied at the same time in a coextrusion process. In a further embodiment of this Figure, the layer 7 is composed as a blend layer like the blend layers 13 and 35.

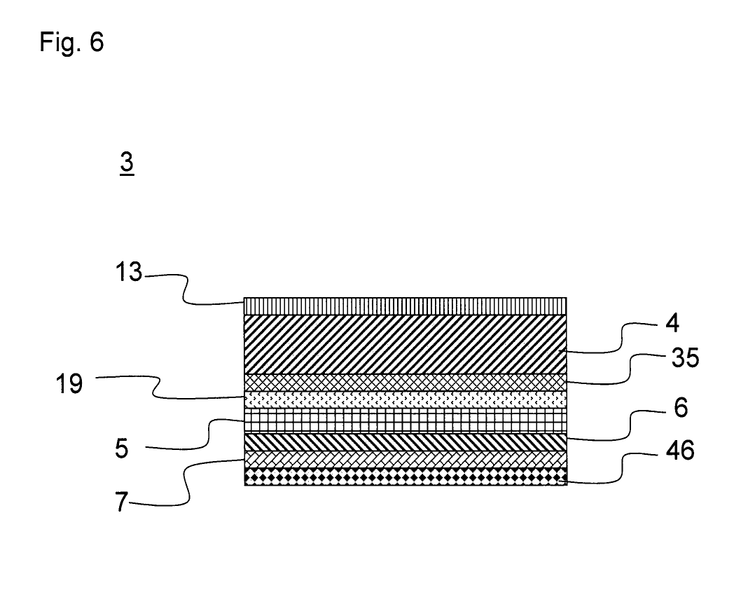

FIG. 7 shows the coating process preferred according to the invention in diagram form 7a. from the front and 7b. from the side. The coating film in the molten state 39 exits an extruder die slot 38 of an extruder die 37 and is applied to the carrier layer 4 via the cooling and pressing rolls 41. The coating film forms the area F which comprises the polymer P1 42, which is followed by a neck-in region 43, which forms the edge regions of the area F. The neck-in region 43 of the area F can be separated off from the area F by cutting tools 44, preferably shearing blades. The molten coating film 39 exits the extruder die 37 with the speed Vₑₓᵢₜ and is accelerated to the speed V_{adv} by the cooling and pressing rolls and thus stretched monoaxially.

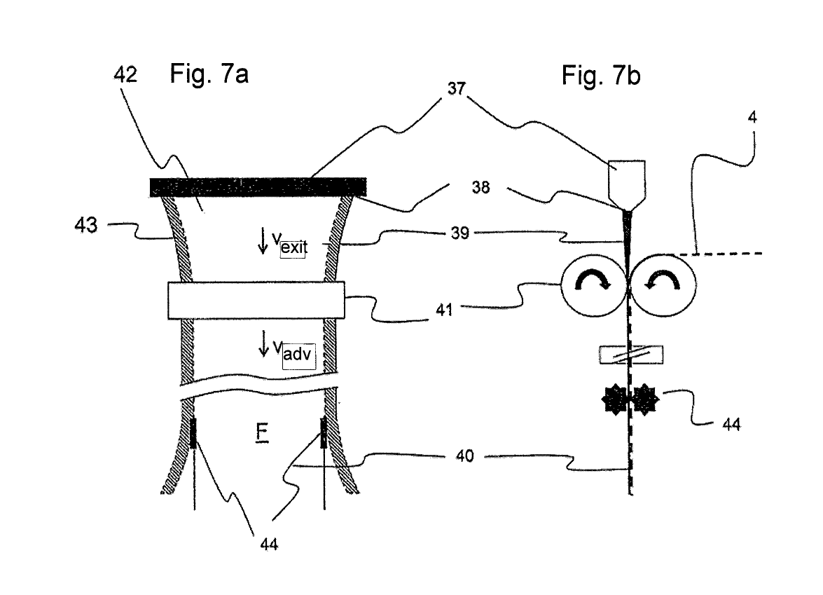

FIG. 8 shows a diagram of the neck-in behaviour of various mixtures of LLDPE and LDPE. As already described above, two different LLDPE, which were mixed with the LDPE already stated in 4 different mixing ratios, were employed here. The mixing ratios are thus plotted on the x-axis 50 and the values for the neck-in on the y-axis 52. The triangles 54 represent the values for the first LLDPE 2. The squares 56 represent the values of the second LLDPE 1. In both cases an LDPE which has a damping factor difference of −0.326 was used in the blend investigated. These values are also to be found in Table 1 from the examples. It is to be clearly seen that the values for the first LLDPE (LLDPE1) 54 and the second LLDPE (LLDPE2) 56, for the mixtures having in each case 60 to 100 wt. %, do not lie on a straight line between the 0 and 100 wt. % of the LLDPE.

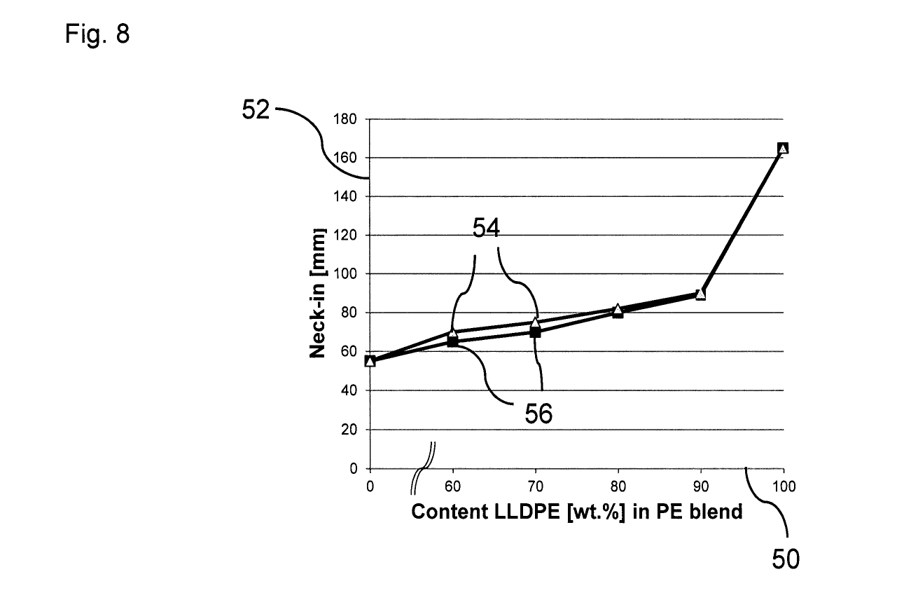

FIG. 9 shows the non-linear behaviour of the damping factor difference with respect to the amount of LLDPE 1 (Ineos® LL2640AC) in the blend layer. Here the blend layer comprises as the LDPE Ineos 23L430 in an amount of the remainder up to 100 wt. % based on the blend layer. The damping factor difference initially decreases very slowly with an addition of LLDPE 1 to an LDPE blend, which is shown by weight contents of LLDPE 1 on the x-axis 50. From a content of approx. 70 wt. % of LLDPE 1 in the PE blend, the damping factor difference drops sharply, shown as the Δ damping factor on the y-axis 52. The diamonds 54 symbolize measurement values for an LDPE blend having the particular stated LLDPE 1 content.

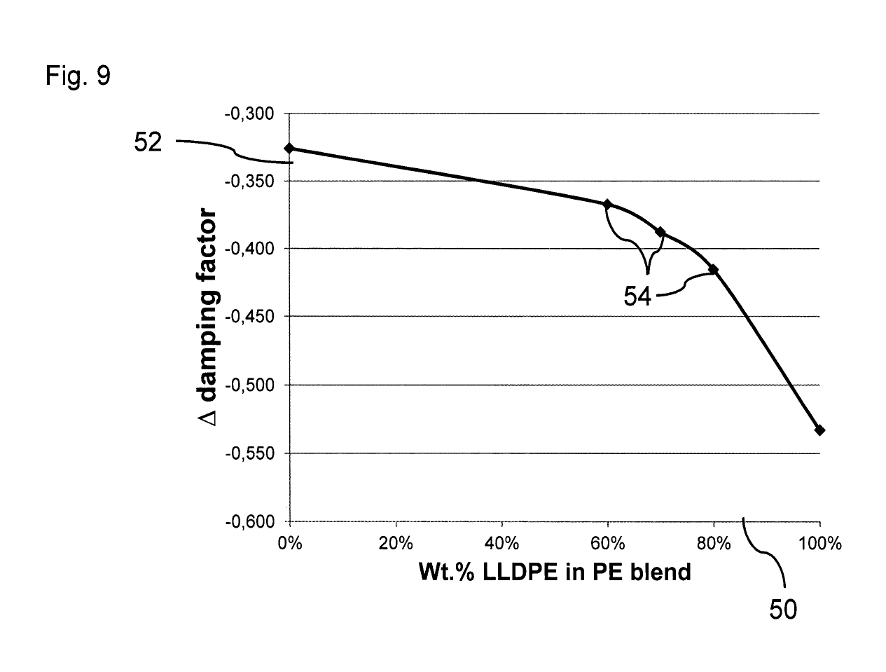

FIG. 10 also shows a non-linear decrease in the maximum draw-down ratio on addition already of small amounts of LDPE to the LLDPE. For this behaviour 3 different mixtures of LLDPE and LDPE, as mentioned in Example 1, were likewise used. The triangles 54 represent the values for the first LLDPE 2. The squares 56 represent the values of the second LLDPE 1. Specifically on addition of LDPE at high contents of LLDPE, in particular in the range between 50 and 80 wt. %, a drastic decrease in the draw-down ratio, plotted on the y-axis 52, against the content of LLDPE on the x-axis 50, is found, which was not to be expected in this way.

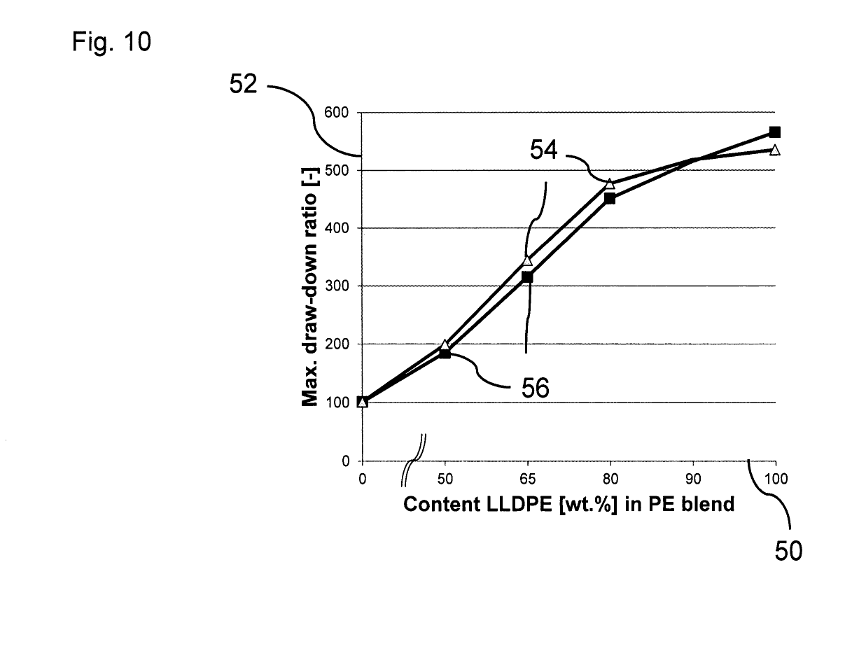

List of reference symbols

| | |
|---|---|
| 1 | Interior |
| 2 | Container |
| 3 | Planar composite |
| 4 | Carrier layer |
| 5 | Barrier layer |
| 6 | EAA layer |
| 7 | Additional blend layer |
| 8 | Fold |
| 9 | Fold surface |
| 10 | Further fold surface |
| 11 | Part region |
| 12 | Container upper side |
| 13 | First blend layer |
| 14 | Score |
| 15 | Part of large area |
| 16 | Part of small area |
| 17 | Edge |
| 18 | Folding tool |
| 19 | Adhesion promoter/Ineos layer |
| 20 | Blend step S0. |
| 21 | Provision step S1. |
| 22 | Application step S2. |
| 23 | Container region |
| 24 | Recess |
| 25 | Bulge |
| 26 | Longitudinal sides |
| 27 | Inner surface |
| 35 | Further blend layer |
| 36 | Opening/perforation |
| 37 | Extruder die |
| 38 | Extruder die slot |
| 39 | Coating film (molten) |
| 40 | Coating film (thermofixed) |
| 41 | Cooling roll, pressing roll |
| 42 | Polymer P1 |
| 43 | Neck-in region |
| 44 | Cutting device |
| 45 | Composite precursor |
| 46 | mPE blend layer |
| 50 | x-axis |
| 52 | y-axis |
| 54 | Values of the first LLDPE (LLDPE 1) |
| 56 | Values of the second LLDPE (LLDPE 2) |

1. A planar composite (3) comprising as a layer sequence:
i. a carrier layer (4);
ii. a barrier layer (5);
wherein the layer sequence comprises a first blend layer (13);
wherein the first blend layer (13) comprises an LLDPE;
wherein the first blend layer (13) comprises the LLDPE in a range of from 10 wt. % to 99.9 wt. %, based on the blend layer (13); and
wherein the first blend layer (13) has a damping factor difference in a range of from −0.3 to −0.6.

2. The planar composite (3) according to claim 1, wherein the blend layer (13) comprises a polyolefin which differs from LLDPE.

3. The planar composite (3) according to claim 1 or 2, wherein the polyolefin which differs from LLDPE is chosen from the group consisting of an LDPE, an HDPE, an m-PE, a polypropylene or a mixture of at least two of these.

4. The planar composite (3) according to one of the preceding claims, wherein the LLDPE has a damping factor difference of less than −0.4.

5. The planar composite (3) according to one of the preceding claims, wherein the first blend layer (13) has a damping factor difference in a range of from −0.32 to −0.50.

6. The planar composite (3) according to one of the preceding claims, wherein the first blend layer (13) has at least one of the following properties:
P1. a melt flow rate (MFR) in a range of from 1 to 15 g/10 min;
P2. a melting temperature (T_{p,m}) in a range of from 100 to 135° C.;
P3. a density in a range of from 0.910 to 0.940 g/cm³;
P4. an average molecular weight (M_{w}) in a range of from 3*10³ to 1*10⁷ g/mol;
P5. prepared with a C₃ to C₁₁ alpha-olefin content in a range of from 0.1 to 15 wt. %, based on the LLDPE.

7. The planar composite (3) according to one of the preceding claims, wherein the LLDPE has at least one of the following properties:
LL1. a melt flow rate (MFR) in a range of from 1 to 15 g/10 min;
LL2. a melting temperature (T_{p,m}) in a range of from 110 to 150° C.;
LL3. a density in a range of from 0.910 to 0.940 g/cm³;
LL4. an average molecular weight (M_{w}) in a range of from 3*10³ to 1*10⁷ g/mol;
LL5. prepared with a C₃ to C₁₁ alpha-olefin content in a range of from 0.1 to 15 wt. %, based on the LLDPE.

8. The planar composite (3) according to one claims 2 to 7, wherein the polyolefin which differs from LLDPE has at least one of the following properties:
L1. a melt flow rate (MFR) in a range of from 1 to 25 g/10 min;
L2. a melting temperature (T_{p,m}) in a range of from 90 to 130° C.;
L3. a density in a range of from 0.900 to 0.940 g/cm³;
L4. an average molecular weight (M_{w}) in a range of from 3*10³ to 1*10⁷ g/mol.

9. The planar composite (3) according to one of claims 2 to 8, wherein the polyolefin which differs from LLDPE is chosen from the group consisting of an LDPE, an LDPEa, an LDPEt or a mixture of at least two of these.

10. The planar composite (3) according to the preceding claim, wherein the LDPEa is obtainable from the reaction in an autoclave.

11. The planar composite (3) according to one of the two preceding claims, wherein the LDPEt is obtainable from the reaction in tubular reactor.

12. The planar composite (3) according to one of the preceding claims, wherein the blend layer (13) contains a metallocene in a concentration of less than 1 wt. %, based on the blend layer (13).

13. The planar composite (3) according to one of the preceding claims, wherein the layer sequence comprises a further blend layer (35);
wherein the further blend layer (35) comprises an LLDPE;
wherein the further blend layer (35) comprises the LLDPE in a range of from 10 wt. % to 99.9 wt. %, based on the further blend layer (35); and
wherein the further blend layer (35) has a damping factor difference in a range of from −0.3 to −0.6.

14. The planar composite (3) according to one of the preceding claims, wherein an additional blend layer (7) is provided in the layer sequence;
wherein the additional blend layer (7) comprises an LLDPE,
wherein the additional blend layer (7) comprises the LLDPE in a range of from 10 wt. % to 99.9 wt. %, based on the additional blend layer (7).

15. The planar composite (3) according to one of claims 2 to 14, wherein the polyolefin which differs from LLDPE is an LDPE;
wherein the LDPE has a damping factor difference of greater than −0.4.

16. The planar composite (3) according to one of claims 9 to 15, wherein the LDPEa has a damping factor difference of greater than −0.4.

17. The planar composite (3) according to one of the preceding claims, wherein the carrier layer (4) comprises a cardboard.

18. The planar composite (3) according to one of the preceding claims, wherein the barrier layer (5) is chosen from
i). a barrier layer of plastic,
ii). a metal layer,
iii). a metal oxide layer or
iv). a combination of at least two of i). to iii).

19. The planar composite (3) according to one of the preceding claims, wherein the carrier layer (4) has at least one hole (36) which is covered at least with the barrier layer (5) and at least with the first blend layer (13), the further blend layer (35) or the additional blend layer (7) or a combination of at least two of these as a hole-covering layer.

20. A process for the production of a planar composite (3), wherein the planar composite (3) comprises a carrier layer (4) and a barrier layer (5); comprising the steps:
S1. provision of a blend comprising an LLDPE;
wherein the blend comprises the LLDPE in a range of from 10 to 99.9 wt. %, based on the blend, and
wherein the blend has a damping factor difference in a range of from −0.3 to −0.6;
S2. application of the blend to a composite precursor (45), wherein the composite precursor (45) comprises a carrier layer (4).

21. The process according to the preceding claim, wherein the blend comprises a polyolefin which differs from LLDPE.

22. The process according to the preceding claim, wherein the LLDPE has a damping factor difference of less than −0.4;
wherein the polyolefin which differs from LLDPE is an LDPE;
wherein the LDPE has a damping factor difference of greater than −0.4.

23. The process according to one of the three preceding claims, wherein the application is carried out through a slot (38).

24. The process according to the preceding claim, wherein the slot (38) and the composite precursor (35) move relative to one another.

25. A planar composite (3) obtainable by a process according to one of claims 20 to 24.

26. A container (2) which surrounds an interior (1) and comprises at least one planar composite (3) according to one of claim 1 to 19 or 25.

27. A process for the production of a container (2) which surrounds an interior (1), comprising the steps
a. provision of a planar composite (3) according to one of claim 1 to 19 or 25;
b. folding of the planar composite (3) to form a fold (8) having at least two fold surfaces (9, 10) adjacent to one another,
wherein the first blend layer (13) faces away from the interior (1) of the container (2);
c. joining of in each case at least a part region (11) of the at least two fold surfaces (9, 10) to form a container region (12);
d. closing of the folded, planar composite (3) with a closing tool.

28. The process according to the preceding claim, wherein the folding is carried out in a temperature range of from 10 to 50° C.

29. The process according to one of the two preceding claims, wherein the joining according to step c. is carried out by irradiation, contact with a hot solid, by mechanical vibration or hot gas or a combination of at least two of these.

30. The process according to one of the three preceding claims, wherein the container (2) is filled with a foodstuff before step b. or after step c.

31. The process according to one of the four preceding claims, wherein the planar composite (3) has at least one score (14) and the fold (8) is effected along the score (14).

32. A container (2) obtainable by a process according to one of claims 27 to 31.

33. A use of a composite according to one of claim 1 to 19 or 25, or of a container according to claim 26 or 32 for storage of foodstuffs.
